(19) United States
(12) Patent Application Publication
(10) Pub. No.: US 2018/0056797 A1
(43) Pub. Date: Mar. 1, 2018

(54) SYSTEMS AND METHODS FOR PROVIDING AN INTELLIGENT CHARGE HANDLE FOR CHARGING A VEHICLE BATTERY

(71) Applicant: Faraday&Future Inc., Gardena, CA (US)

(72) Inventors: Chi Hung Cao, Huntington Beach, CA (US); Richard S. Kim, Los Angeles, CA (US); Mike de Jung, Marina del Rey, CA (US); Jason Huang, Fremont, CA (US)

(21) Appl. No.: 15/693,207

(22) Filed: Aug. 31, 2017

Related U.S. Application Data
(60) Provisional application No. 62/382,083, filed on Aug. 31, 2016.

(51) Int. Cl. B60L 11/18; H01R 13/641

(52) U.S. Cl. CPC B60L 11/1818; B60L 2230/16; B60L 2230/12; H01R 13/641

(57) ABSTRACT

Systems, methods, and apparatus for providing intelligent charge handle for charging a vehicle battery are provided. Implementations of the disclosed technology may include a charge handle having: alignment fins to properly align electrical contacts, movement sensors configured to detect when the charge handle has been picked up and to effectuate activation of the charge handle's charging capabilities in response thereto, touch sensors configured to detect a user's touch and to effectuate activation of a light illuminating the path of insertion in response thereto, and/or a multi-stage electrical connector having multiple conductors carrying different signals, where more than one of the multiple conductors is physically accessible via a single aperture in the charge handle housing (e.g. through a faceplate).

### CROSS-REFERENCE TO RELATED APPLICATIONS

This application claims the benefit of U.S. Provisional Application No. 62/382,083, filed Aug. 31, 2016, the entirety of which is hereby incorporated by reference.

### TECHNICAL FIELD

The present disclosure relates generally to battery charging technologies, and more particularly to devices, systems and methods for providing an intelligent charge handle for charging in-vehicle batteries.

### BACKGROUND OF THE DISCLOSURE

Conventional charge handles for electric vehicles do not intelligently meet the needs of users who wish to operate them, nor do they provide adequate structural features to ensure proper alignment of the charge handle (and/or components of the charge handle) when the handle is plugged into a charging port. Moreover, conventional charge handles do not employ an effective conductor pin arrangement, leading to large and bulky designs that often make them cumbersome to maneuver. Further, conventional charge handles do not intelligently provide solutions to increase visibility along the insertion path when lighting is poor. Moreover, conventional charge handles cannot intelligently access that a user intends to make use of the charge handle when the user picks it up.

### BRIEF SUMMARY OF THE DISCLOSURE

The present disclosure is directed to systems and methods for providing an intelligent charge handle for charging vehicle batteries. As discussed in more detail below, embodiments of the disclosed technology may include a charge handle having one or more alignment fins to properly align electrical contacts, movement sensors configured to detect when the charge handle has been picked up by a user (and further to prompt activation of the charge handle's power supply to charge a vehicle battery in response thereto), touch sensors configured to detect a user's touch (and further to prompt activation of a light illuminating the path of insertion in response thereto), and/or a multi-stage electrical connector having multiple conductors carrying different signals, each of the multiple conductors being physically accessible via a single aperture in a charge handle housing (e.g. through the charge handle interface, faceplate, etc.).

A charge handle in accordance with the embodiments of the present disclosure may include a housing at least partially enclosing one or more charging conductors configured to be mated with one or more complementary conductors of a charging port (also referred to herein as a “charge port”); and one or more alignment fins extending from a first end (e.g. a front end) of the housing in a longitudinal direction, wherein the alignment fins have a tapered profile configured to engage with an opening of the charge port to align the one or more charging conductors of the charge handle with the one or more complementary conductors of the charge port as the charge handle is inserted into the charge port.

In some embodiments, the tapered profile of the alignment fins is defined by an outer surface portion of the alignment fin sloping inward toward a longitudinal axis of the charge handle as the alignment fin extends further from the housing. In some embodiments, the tapered profile of the alignment fins is defined by an inner surface portion of the alignment fin sloping away from the longitudinal axis of the charge handle, as the alignment fin extends further from the housing.

In some embodiments, the alignment fin is configured to engage with an interior side wall of the opening of the charge port. In some embodiments, the alignment fin is configured to engage with a complementary conductor or conductor port projecting out of the charge port wall. In some embodiments, the alignment fin is configured to engage with an exterior side wall of the opening of the charge port. In some embodiments, the alignment fins are releasably coupled with the housing. In other embodiments, the alignment fins are non-releasably coupled with the housing. In some embodiments, the housing includes a first number of apertures providing physical contact access to a second number of charging conductors, wherein the second number of charging conductors is greater than the first number of apertures. In some embodiments, a first material of a surface portion of one or more of the alignment fins is softer than a second material of a surface portion of the housing. In some embodiments, the one or more alignment fins include a rubber material and/or a plastic material.

In some implementations, the charge handle of the present disclosure may include: a housing enclosing one or more charging conductors, the housing having one or more alignment fins extending from a front end of the housing and beyond the charging conductors in at least one direction, wherein the alignment fins have a tapered profile configured to engage with an opening of a charge port to align the charge handle with the charge port as the charge handle is inserted into the charge port.

In some embodiments, the tapered profile of the alignment fins is defined by an outer surface portion of the alignment fin sloping inward toward a longitudinal axis of the charge handle as the alignment fin extends further from the housing. In some embodiments, the tapered profile of the alignment fins is defined by an inner surface portion of the alignment fin sloping away from a longitudinal axis of the charge handle, as the alignment fin extends further from the housing.

In some embodiments, the alignment fins are configured to engage with an interior side wall of the opening of the charge port. In some embodiments, the alignment fins are configured to engage with a complementary conductor or conductor port projecting out of the charge port wall. In some embodiments, the alignment fins are configured to engage with an exterior side wall of the opening of the charge port. In some embodiments, the alignment fins are releasably coupled with the housing. In other embodiments, the alignment fins are non-releasably coupled with the housing. In some embodiments, the housing includes a first number of apertures providing physical contact access to a second number of charging conductors, wherein the second number of charging conductors is greater than the first number of apertures. In some embodiments, a first material of a surface portion of one or more of the alignment fins is softer than a second material of a surface portion of the housing. In some embodiments, the one or more of the alignment fins include a rubber material and/or a plastic material.

In still further implementations of the present disclosure, a charge handle in accordance with some embodiments may include: a housing at least partially enclosing one or more charging conductors, the charging conductors configured to be coupled to an energy source; a sensor carried by the housing and configured to detect a user interaction with the sensor; and a light source carried by the housing and operatively coupled with the sensor, wherein the light source is configured to be activated or deactivated based on a user interaction with the sensor. In some embodiments, the sensor includes a capacitive sensor, a resistive sensor, or a piezoelectric sensor. In some embodiments, the sensor is configured to detect an applied force, a contact with one or more of a living tissue, a nearby material having a dielectric different than air, and/or a conductor (e.g. a conducing material in contact therewith). In some embodiments, the light source includes a light-emitting diode configured to illuminate an area exterior to the housing in front of the charging conductors. In some embodiments, the light source includes an incandescent filament configured to illuminate an area exterior to the housing in front of the charging conductors. In some embodiments, the sensor is configured to detect a pattern of one or more contact occurrences. In some embodiments, the pattern is associated with an operation of the charge handle. In some embodiments, the sensor is configured to detect one or more patterns of one or more contact occurrences, each pattern being associated with an operation of the charge handle. In some embodiments, the pattern is associated with an operation of the vehicle.

In some implementations, a charging feature may be actuated based on the sensor detecting a pattern associated with one or more contact occurrences. The charging feature includes one or more of: an AC line, a DC line, and a status indicator operatively coupled with the housing. In some embodiments, a vehicle feature may be actuated based on the sensor detecting a pattern associated with one or more contact occurrences. The vehicle feature includes one or more of: a vehicle cabin light feature, a vehicle headlight feature, a vehicle HVAC system feature, a window defrost feature, and/or a vehicle seat adjustment feature.

In some implementations, the sensor includes a resistive sensor. In other implementations, the sensor includes a piezoelectric sensor. In some implementations, the charge handle or a charge handle assembly (e.g., inclusive of a charging station or devices on the charging station coupled to the charge handle, the charging port, etc.) includes a plurality of different of sensors.

In some implementations, a charge handle assembly of the present disclosure may include: a housing at least partially enclosing a plurality of charging conductors, the charging conductors configured to be coupled to an energy source; a touch sensor carried by the housing; a light source carried by the housing and operatively coupled with the touch sensor; and one or more physical computer processors operatively coupled to the touch sensor and the light source, the physical computer processors configured by computer readable instructions to: receive information indicating the touch sensor has detected one or more occurrences of contact (e.g. human touch); and/or activate or deactivate the light source based on the information. In some embodiments, the physical computer processors are further configured to: identify a pattern associated with one or more occurrences of contact (e.g. one or more human touch events); and/or adjust the intensity of the light source based on the pattern identified. In some embodiments, the touch sensor includes one or more of a capacitive sensor, a resistive sensor, and/or a piezoelectric sensor. In some embodiments, the light source includes a light-emitting diode configured to illuminate an area exterior to the housing in front of the charging conductors(e.g. in front of the faceplate). In some embodiments, the light source includes an incandescent filament configured to illuminate an area exterior to the housing in front of the charging conductors.

In some implementations, the one or more physical computer processors are further configured to: identify a pattern associated with one or more occurrences of contact; and/or actuate a charging feature based on the pattern identified. The charging feature may include one or more of: an AC line, a DC line, and/or a status indicator. In some embodiments, the one or more physical computer processors are further configured to: identify a pattern associated with one or more occurrences of contact; and/or actuate a vehicle feature based on the pattern identified. The vehicle feature may include one or more of: a charge port door feature, a vehicle cabin light feature, a vehicle headlight feature, a vehicle HVAC system feature, a window defrost feature, and/or a vehicle seat adjustment feature.

An exemplary method for actuating a light (e.g. a flashlight) on a charge handle in accordance with one or more embodiments may include: detecting one or more contacts (e.g. human touch events) on a sensor carried by a housing of a charge handle; identifying a first pattern of the one or more contacts; and/or actuating a light source coupled to the housing of the charge handle based on the identified first pattern. An exemplary method in accordance with some implementations may further include identifying a second pattern of the one or more contacts on the sensor; actuating a charging feature of the charge handle based on the identified second pattern, wherein the charging feature includes one or more of: an AC line, a DC line, and/or a status indicator. In some implementations, an exemplary method in accordance with the present disclosure may further include: identifying a second pattern of the one or more contacts on the sensor; and/or actuating a vehicle feature based on the identified second pattern, wherein the vehicle feature includes one or more of: a charge port door feature, vehicle cabin light feature, a vehicle headlight feature, a vehicle HVAC system feature, a window defrost feature, and/or a vehicle seat adjustment feature.

In some implementations, a charge handle in accordance with one or more embodiments of the present disclosure may include: a housing at least partially enclosing one or more charging conductors, the charging conductors configured to be coupled to an energy source; and a sensor carried by the housing and configured to detect movement of the housing, wherein at least one of the charging conductors is actuated based on a first detected movement. In some embodiments, at least one of the charging conductors is deactivated based on a second detected movement. In some embodiments, the sensor includes a motion sensor configured to detect a motion of the charge handle. In some embodiments, the motion sensor includes an accelerometer. In some embodiments, the sensor includes a proximity sensor configured to detect whether the charge handle has been moved into or out of a defined spatial region. In some embodiments, the proximity sensor includes a magnetic sensor. In some embodiments, the proximity sensor includes an RF tag operatively coupled with a remote RF receiver.

In some implementations, the sensor is configured to detect a pattern of movement and the charge handle is configured to activate a charging feature based on the detected pattern. The charging feature may include one or more of: an AC line, a DC line, and a status indicator operatively coupled with the housing. In some embodiments, the sensor is configured to detect a pattern of movement and the charge handle is configured to activate a vehicle feature based on the detected pattern of movement. The vehicle feature may include one or more of: a charge port door feature, a vehicle cabin light feature, a vehicle headlight feature, a vehicle HVAC system feature, a window defrost feature, and/or a vehicle seat adjustment feature.

In some implementations, a charge handle assembly in accordance with one or more embodiments of the present disclosure may include a housing at least partially enclosing one or more charging conductors, the charging conductors configured to be coupled to an energy source; a sensor carried by the housing and configured to detect movement of the housing; and one or more physical computer processors operatively coupled to the sensor and one or more of the charging conductors, the physical computer processors configured by computer readable instructions to: receive information indicating the movement sensor has detected one or more movement occurrences; and/or actuate at least one of the charging conductors based on the movement information.

In some implementations, the physical computer processors are further configured to: identify a pattern of movement based on the movement information; and/or actuate a charging feature based on the pattern identified. The charging feature may include one or more of: an AC line, a DC line, and/or a status indicator. In some implementations, the physical computer processors are further configured to: identify a pattern of movement based on the movement information; and/or actuate a vehicle feature based on the pattern identified. The vehicle feature may include one or more of: a charge port door feature, a vehicle cabin light feature, a vehicle headlight feature, a vehicle HVAC system feature, a window defrost feature, and/or a vehicle seat adjustment feature.

An exemplary method for actuating a conductor on a charge handle in accordance with one or more embodiments may include: detecting one or more movements of a charge handle via a movement sensor carried by a housing of the charge handle; and actuating a power supply line based on the detected one or more movements. In some embodiments, the method further comprises identifying a pattern of the one or more movements; and actuating the power supply line based on the detected pattern of the one or more movements. In some embodiments, the power supply line includes one or more of an AC line or a DC line.

In some implementations, a charge handle of the present disclosure may include a multi-stage connector (e.g. a multistage inlet connector or a multistage outlet connector) including: a first conductor and a second conductor coupled together to form a single body having a tip-ring configuration; and a first insulator disposed between the first conductor and the second conductor; wherein the first conductor is configured to carry one of a pilot signal, a proximity signal, and/or a communication signal; and/or wherein the second conductor is configured to carry another one of a pilot signal, a proximity signal, and/or a communication signal.

In some implementations, a multi-stage connector in accordance with embodiments of the present disclosure may further include a third conductor coupled together with the first and second conductors to form a single body having a tip-ring-sleeve configuration; and a second insulator disposed between the second conductor and the third conductor; wherein the third conductor is configured to carry a remaining one of a pilot signal, a proximity signal, and/or a communication signal.

In some implementations, a multi-stage connector in accordance with embodiments of the present disclosure may further include a fourth conductor coupled together with the first, second, and third conductors to form a single body having a tip-ring-ring-sleeve configuration; and a third insulator disposed between the third conductor and the fourth conductor, wherein the fourth conductor is coupled to ground. In some embodiments, the first conductor and the second conductor are physically accessible through a single aperture in a charge handle housing. In some embodiments, the first conductor, the second conductor, and the third conductor are physically accessible through a single aperture in a charge handle housing. In some embodiments, the first conductor, the second conductor, the third conductor, and the fourth conductor are physically accessible through a single aperture in a charge handle housing.

In some implementations, a multi-stage connector in accordance with embodiments of the present disclosure may include: a first conductor, a second conductor, and a third conductor, wherein the first conductor, the second conductor, and the third conductor are arranged in a tip-ring-sleeve configuration in a single body. In some implementations, the first conductor is configured to carry any one or more of an AC power supply, a DC power supply, and/or a pilot signal; the second conductor is configured to carry any one or more of an AC power supply, a DC power supply, and/or a pilot signal; and/or the third conductor is configured to carry any one or more of an AC power supply, a DC power supply, and/or a pilot signal. In some embodiments, a multi-stage connector in accordance with embodiments of the present disclosure may further include a fourth conductor, wherein the fourth conductor is arranged in a tip-ring-ring-sleeve configuration with the first, second, and third conductors in a single body, and wherein the fourth conductor is coupled to ground.

In some embodiments, the first conductor is configured to carry a first AC line, the second conductor is configured to carry a second AC line, and/or the third conductor is configured to carry a pilot signal. In some embodiments, the first conductor, second conductor, and/or third conductor is configured to carry a DC line. A person having ordinary skill in the art should appreciate that the discussion of multi-stage connectors of the present disclosure is equally applicable to multi-stage inlet connectors and multi-stage outlet connectors. In particular, any one or more of the embodiments of the present disclosure may include either multi-stage inlet connectors (a stacked inlet pin), or multistage outlet connectors (a stacked outlet receptacle), or any combination of both. Although not specifically depicted in the figures provided with the instant disclosure, one of ordinary skill in the art will readily appreciate that the charge handle housing may, in some embodiments, be configured to enclose one or more outlet connectors (one or more of which may be a multi-stage outlet connector) instead of inlet connectors, or, in some embodiments include a combination of both inlet and outlet connectors.

In some implementations, a charging assembly of the present disclosure may include an electrical connector including a first conductor configured to carry one of a pilot signal configured to indicate that a charge handle is connected to a charge port (e.g. so that charging may commence), a proximity signal configured to indicate that the charge handle is about to be disconnected from the charge port, or a communication signal configured to transmit information between the charge handle and the charge port; a second conductor configured to carry another one of the pilot signal, the proximity signal, or the communication signal; a first insulator disposed between the first conductor and the second conductor, and the first conductor and the second conductor are aligned along a same longitudinal axis. In some implementations the electrical connector further includes a third conductor configured to carry a remaining one of the pilot signal, the proximity signal, or the communication signal, and/or a second insulator disposed between the second conductor and the third conductor, wherein the third conductor may be positioned adjacent to the second conductor, and the third conductor and the second conductor are aligned along a same longitudinal axis. In some implementations the electrical connector further includes a fourth conductor configured to be coupled to a ground; a third insulator disposed between the third conductor and the fourth conductor; wherein the fourth conductor positioned adjacent to the third conductor, and the fourth conductor and the third conductor are aligned along a same longitudinal axis.

In some implementations, the first conductor and the second conductor of an exemplary electrical connector are physically accessible through a single aperture in a charge handle housing. In some implementations, the first conductor, the second conductor, and the third conductor are physically accessible through a single aperture in a charge handle housing. In some implementations, the first conductor, the second conductor, the third conductor, and the fourth conductor are physically accessible through a single aperture in a charge handle housing.

In some implementations, the first conductor is configured to carry a pilot signal, the second conductor is configured to carry a proximity signal, and the third conductor is configured to carry a communication signal.

These and other objects, features, and characteristics of the present disclosure, as well as the methods of operation and functions of the related components of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the any limits. As used in the specification and in the claims, the singular form of “a”, “an”, and “the” include plural referents unless the context clearly dictates otherwise.

### BRIEF DESCRIPTION OF THE DRAWINGS

Various embodiments are disclosed herein and described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a perspective view or an exemplary charge handle for charging a vehicle battery including various components thereof in accordance with one or more embodiments of the present disclosure.

FIG. 2 is a cross sectional side view of a portion of an exemplary charge handle including alignment fins in accordance with one or more embodiments of the present disclosure.

FIG. 3A depicts a cross sectional side view of a portion of an exemplary charge handle in accordance with one or more embodiments of the present technology, the charge handle positioned outside a complementary charge port receptacle.

FIG. 3B depicts a cross sectional side view of a portion of an exemplary charge handle in accordance with one or more embodiments of the present technology, the charge handle partially inserted within a complementary charge port receptacle.

FIG. 3C depicts a cross sectional side view of a portion of an exemplary charge handle in accordance with one or more embodiments of the present technology, the charge handle fully inserted within a complementary charge port receptacle.

FIG. 3D depicts a cross sectional side view of a portion of a charge handle lacking alignment fins, the charge handle positioned outside a complementary charge port receptacle.

FIG. 3E depict a cross sectional side view of a portion of an charge handle lacking alignment fins, the charge handle misaligned with a complementary charge port receptacle.

FIG. 3F depict a cross sectional side view of a portion of an charge handle lacking alignment fins, the charge handle misaligned a complementary charge port receptacle.

FIG. 4 illustrates an exemplary arrangement of conductors (e.g. pins) carried by a charge handle housing in accordance with one or more embodiments of the present disclosure.

FIG. 5A illustrates a cross-sectional side view of an exemplary tip-ring-sleeve stacked conductor arrangement in accordance with one or more embodiments of the present technology.

FIG. 5B illustrates a cross-sectional in-plane view of the exemplary tip-ring-sleeve stacked conductor arrangement depicted in FIG. 5A in accordance with one or more embodiments of the present disclosure.

FIG. 6 illustrates a component diagram of an exemplary charge handle system including touch sensor(s) that may be implemented in accordance with one or more embodiments of the present technology.

FIG. 7 illustrates a flow chart of a method that may be implemented by charge handle systems in accordance with one or more embodiments of the present disclosure.

FIG. 8 illustrates a component diagram of an exemplary charge handle system including a movement sensor that may be implemented in accordance with one or more embodiments of the present technology.

FIG. 9 illustrates a flow chart of a method that may be implemented by charge handle systems in accordance with one or more embodiments of the present disclosure.

FIG. 10 illustrates a perspective exterior view of an exemplary charge handle in accordance with one or more embodiments of the present disclosure.

FIG. 11A illustrates a top exterior view of an exemplary charge handle in accordance with one or more embodiments of the present disclosure.

FIG. 11B illustrates a bottom exterior view of an exemplary charge handle in accordance with one or more embodiments of the present disclosure.

FIG. 12A illustrates a rear exterior view of an exemplary charge handle in accordance with one or more embodiments of the present disclosure.

FIG. 12B illustrates a front exterior view of an exemplary charge handle in accordance with one or more embodiments of the present disclosure.

FIG. 13A illustrates a side exterior view of an exemplary charge handle in accordance with one or more embodiments of the present disclosure.

FIG. 13B illustrates a side exterior view of an exemplary charge handle in accordance with one or more embodiments of the present disclosure.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION

The present disclosure is directed to devices, systems, methods for providing an intelligent charge handle for charging a vehicle battery. As explained in more detail below, a charge handle in accordance with the systems and methods of the present disclosure may include a housing at least partially enclosing multiple charging conductors (the charging conductors configured to be mated with complementary conductors of a charging port (also referred to herein as a “charge port”); and/or one or more alignment fins coupled with the housing and extending from a front end of the housing and beyond the charging conductors in at least one direction (e.g. in an insertion direction), wherein the alignment fins have a tapered profile configured to engage with a structure of a charge port as the charge handle is inserted into the charge port, the engagement effectuating a change in lateral position of the charging conductors as the charge handle proceeds deeper into the plug (i.e. deeper into the socket) of the charge handle.

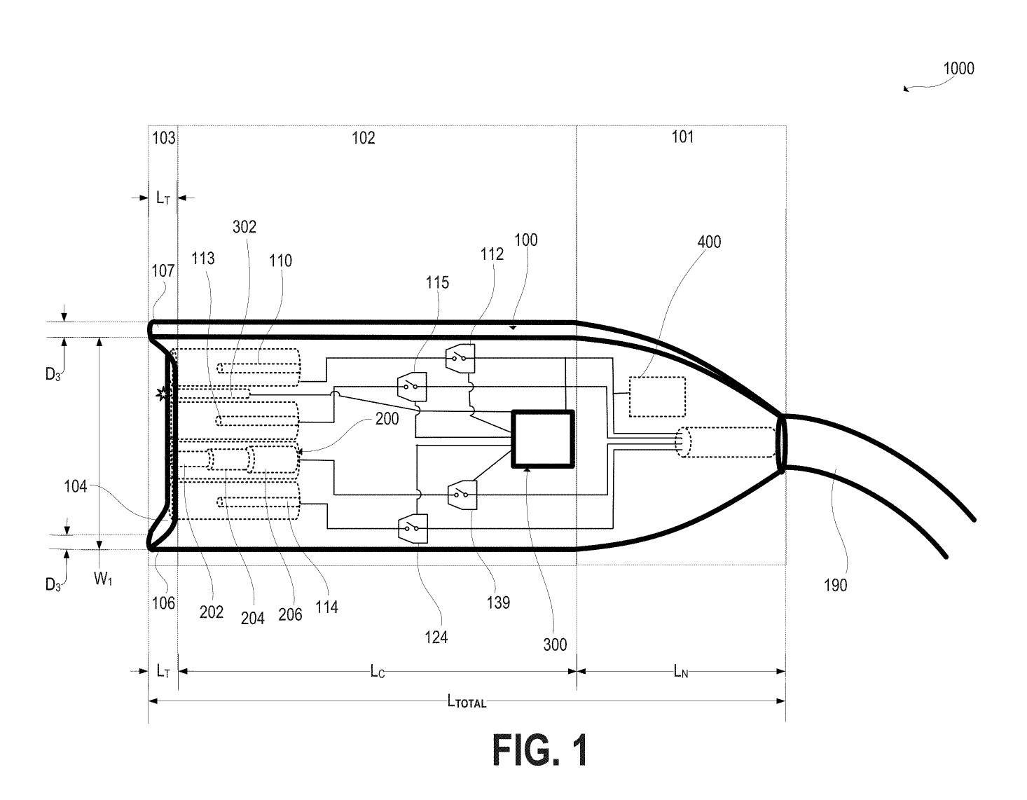

FIG. 1 illustrates a perspective view of an exemplary charge handle for charging a vehicle battery, including various components thereof in accordance with one or more embodiments of the present disclosure. As depicted, a charge handle 1000 in accordance with the present disclosure may include a housing 100 configured with one or more alignment fins 106, 107; a touch sensor 300 operatively coupled with a light source (e.g. light source 302), a movement sensor 400 operatively coupled with a power supply line (e.g. power supply line 111), and/or a multistage inlet connector 200 having a plurality of physically accessible conductors configured to carry different signals.

Housing 100 may be a substantially hollow enclosure of any type configured to carry one or more electronic and/or electrical components, including one or more sensors, conductors, cables/wires, circuits, switches, gates, gauges, transmitters, receivers, transceivers, modems, computer processing components (e.g., physical computer processors), memory, any or any other electronic or electrical components or connectors. A housing 100 in accordance with one or more embodiments of the present technology may be generally described as having three subsections including a neck 101, a core 102, and a tip 103. The neck 101, the core 102, and/or the tip 103 subsections may be configured as hollow sleeves joined together at their edges, or a series of subcomponents that when joined together form a hollow enclosure configured to carry or otherwise enclose various electronic, electrical, and/or mechanical components. In some embodiments, neck 101, core 102, and tip 103 may be distinct components that are joined together to form the housing 100 structure. The neck 101, core 102 and tip 103 may be permanently or temporarily (e.g. releasably) coupled together to form the housing structure. In some embodiments, any one or more of neck 101, core 102, and tip 103 may be integrally formed as a single unit (i.e. not as separate components joined together) such that one conceptual region of the housing flows seamlessly into the other. The housing 100 as a whole, or any one or more of the neck 101, core 102, and tip 103 portions/regions/components may be made of any material or combination of materials. The housing 100 as a whole, or any one or more of the neck 101, core 102, and tip 103 may be made up of any one or more subcomponents joined together.

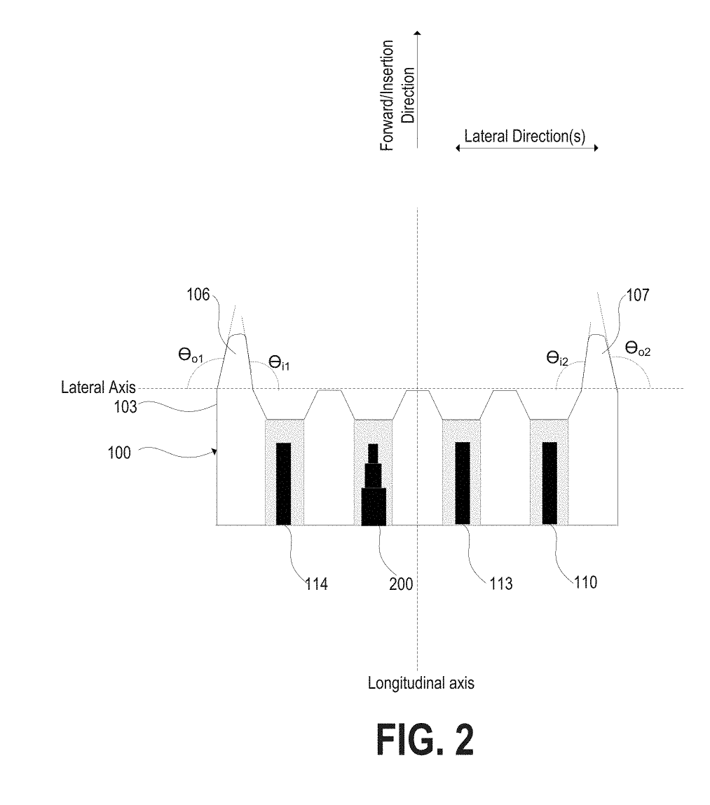

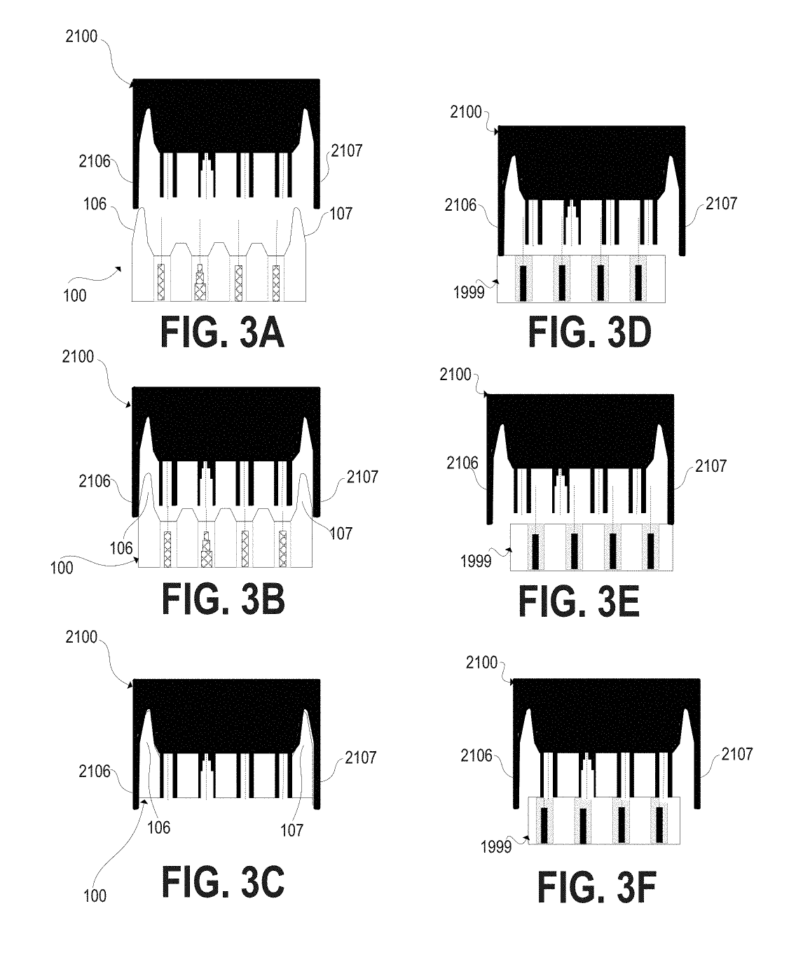

As will be discussed in more detail herein with reference to FIGS. 2 and 3A-C, in some embodiments, the tip 103 portion of housing 100 is configured with one or more alignment fins 106, 107. For example, one or more portions of tip 103 side walls may extend to a greater distance from the front end of core 102 at some points along the core 102 edge than at other points along the core 102 edge (e.g. side walls/alignment fins 106, 107 of tip 103 extend to a distance, L_{T} from the leading edge of core 102 at two sides (denoted by the location of alignment fins 106, 107 in FIG. 1) that is greater than the distance tip extends from the core edge at other points along core 102 edge. As shown, the tip 103 may define or otherwise include one or more alignment fins 106, 107 configured to maneuver the position of the charge handle 1000 as it is inserted into the cavity of a charge port. Embodiments of fins 106, 107 and/or tip 103 are discussed in more detail herein with reference to FIGS. 2, 3A-3C.

FIG. 2 is a cross-sectional side view of a portion of an exemplary charge handle tip 103 including alignment fins 106, 107 in accordance with one or more embodiments of the present disclosure. As shown, a charge handle of the present disclosure may be configured with one or more alignment fins 106, 107 coupled with, carried by or otherwise extending from the front end of the housing 100) and extending outward beyond conductors 114, 202, 204, 206, 110 in at least one direction (e.g., as shown, in the forward/insertion direction). The alignment fins 106 and 107 have a tapered profile on either or both of their inside surface and/or outside surface. The taper (i.e. the sloped edge) of at least one of the alignment fins 106, 107 may be configured to guide or adjust a lateral position of the charge handle housing 100 (and thereby the conductors 114, 202, 204, 206, 110) such that the charging conductors move into an aligned position (or otherwise preferred position with respect to the electrical connectors of the complementary charge port) as the charge handle is inserted into the cavity of a charge port.

As shown in FIG. 2, in some embodiments, at least a portion of the surface of alignment fin 106 may slope, taper, or gradually tend inward toward the central longitudinal axis of housing 100. That is, at least a portion of the surface that defines alignment fin 106 tapers such that a line tangent to the portion of the surface will create an angle, θ_{O1}, with the negative lateral axis greater than 90 degrees (as shown). In some embodiments, an outer surface of alignment fin 106 may slope, taper, or gradually tend inward toward the central longitudinal axis of housing 100 in the forward/insertion direction.

As further shown in FIG. 2, in some embodiments, at least a portion of the surface of alignment fin 107 may slope, taper, or gradually tend inward toward the central longitudinal axis of housing 100. That is, at least a portion of the surface that defines alignment fin 107 tapers such that a line tangent to the portion of the surface will create an angle, θ_{O2}, with the positive lateral axis that is greater than 90 degrees. As shown, in some embodiments an outer surface of alignment fin 107 may slope, taper, or gradually tend inward toward the central longitudinal axis of housing 100 in the forward/insertion direction. It should be noted that θ_{O1} and θ_{O2} may be equal or may be different.

As shown, in some embodiments, an inner surface of alignment fin 106 may slope, taper, or gradually tend away from the longitudinal axis of housing 100 in the forward/insertion direction. That is, at least a portion of the surface that defines alignment fin 106 tapers such that a line tangent to the portion of the surface will create an angle, θᵢ₁, with lateral axis that is greater than 90 degrees. As shown, in some embodiments, an inner surface of alignment fin 107 may slope, taper, or gradually tend away from the longitudinal axis of housing 100 in the forward/insertion direction. That is, at least a portion of the surface that defines alignment fin 107 tapers such that a line tangent to the portion of the surface will create an angle, θᵢ₂, with lateral axis greater than 90 degrees. It should be noted that θᵢ₁ and θᵢ₂ may be equal or may be different.

In some embodiments, only an inside edge or an outside edge of an alignment fin will display a taper. For example, in some embodiments, θₒ₁ and/or θₒ₂ are 90 degrees, but θᵢ₁ and θᵢ₂ are greater than 90 degrees. In another example, in some embodiments, θᵢ₁ and/or θᵢ₂ are 90 degrees, but θₒ₁ and θₒ₂ are greater than 90 degrees.

In some embodiments, the outer surface of the alignment fins 106, 107 may have a conical shape and the inner surface may have a cylinder shape. The front end of the alignment fins 106, 107 may be rounded, allowing easy alignment with and insertion into an opening. In some embodiments, the slope of the taper of the alignment fins is adjustable. For example, the alignment fins 106, 107 may be rotatably coupled with the housing 100, the alignment fins 106, 107 being capable of being locked into a particular rotation position (and, thereby, a particular slope) by a locking mechanism (e.g. a locking pin, a tightening knob, etc.)

As described in more detail with reference to FIGS. 3A-3C, alignment fins 106, 107 may be configured to display a taper or a slope or other structural feature that may slideably engage a portion of the structure of the charge port/socket and thereby guide the housing 100 to move laterally into a desired position as the handle 100 is inserted into a charge socket. In this way, alignment fins 106, 107 may ensure that electrical inlets such as conductors 110, 113, 114, 202, 204, and 206 are properly aligned with their complementary charge port connectors in the charge port (thereby ensuring proper contact is made between connectors).

FIG. 3A depicts a cross sectional side view of a portion of an exemplary charge handle housing 100 in accordance with one or more embodiments of the present technology, the charge handle positioned outside a complementary charge port 2100. As shown, charge handle housing 100 is not properly aligned with the opening in the charge port, i.e., the conductors are not vertically aligned with their complement port connectors. For example, if charge handle 100 was moved toward charge port 2100, alignment fin 106 would come into contact with a portion of side wall 2106 of charge port 2100. On account of the taper of alignment fin 106, however, housing 100 may slide against side wall 2106 in a manner that moves housing 100 to the right as it is inserted further into the charge port 2100. FIG. 3B depicts a cross sectional side view of a portion of the exemplary charge handle housing 100 of FIG. 3A, shown here as having been partially inserted within charge port 2100. Taking FIGS. 3A and 3B together, it may be observed that as charge handle 100 is moved toward and into charge port 2100, the sloped outer surface of alignment fin 106 will contact charge port side wall 2106 and cause the lateral position of housing 100 to move such that the alignment of the conductors will be centered with their complementary counterpart connectors within the charge port 2106. FIG. 3C depicts a cross sectional side view of a portion of the exemplary charge handle housing 100 of FIG. 3A, shown here as having been fully inserted within charge port 2100. As may be observed, the sloped outer surface of alignment fins 106 and/or 107 may contact charge port side walls 2106 and/or 2107 and, as the charge handle 100 is pressed into the charge port 2100 receptacle, serve to align the conductors of the charge handle 100 with their counterpart connectors within charge port 2100. One of ordinary skill in the art will appreciate that alignment fins may be configured to align conductors within any style of charge handle with the complementary charge connectors within any style of charge port 2100 receptacle. In some embodiments, alignment fins may be configured to cause the position of the charge handle to move (e.g. right to left, up or down, etc.) such that the alignment of the conductors of the charge handle will be centered with their counterpart connectors within the charge port 2106. Alignment fins in accordance with the present disclosure (e.g. alignment fins 106, 107) may provide easier operability to a user. With alignment fins employed, a user need not waste time trying to perfectly align the charge handle with the charge port pins. Moreover, because alignment fins may avoid the situation where a user attempts to force a misaligned charge handle into a charge port, alignment fins also serve to preserve the structural integrity of the electrical connectors and/or other components of a charge handle and/or charge port.

As shown in FIGS. 3D-3E, when alignment fins are not employed, aligning conductors with counterpart connectors may be more difficult, less precise, and/or more harmful to one or more components. FIG. 3D depicts a cross sectional side view of a portion of a charge handle housing 1999 lacking alignment fins, the charge handle housing 1999 positioned outside a complementary charge port 2100. As shown, charge handle housing 1999 is not properly aligned with the opening in charge port 2100, i.e., the conductors are not vertically aligned with their complement port connectors. For example, if charge handle housing 1999 was moved toward the charge port 2100, the far left edge of the charge handle housing 1999 would impact a portion of side wall 2106 of charge port 2100. However, instead of sliding laterally into alignment with additional insertion (as is made possible with alignment fins in accordance with the present disclosure) charge handle 1999 is prevented, without more, from being further inserted into the charge port 2100. Accordingly, a user must apply a specific lateral force themselves to move charge handle 1999 into the desired position. Often this can take several attempts, especially if the user's motor skills are limited. FIGS. 3E and 3F also depict a cross sectional side view of a portion of an charge handle housing 1999 lacking alignment fins, the charge handle housing 1999 misaligned (in different positions) with complementary charge port 2100 receptacle. In each instance, instead of sliding laterally into alignment as it is inserted into charge port 2100, charge handle housing 1999 is prevented, without more, from being further inserted into the charge port 2100. Accordingly, a user must apply the lateral force themselves to move charge handle 1999 into the correct position. Again, this can often take several attempts, and consequently more time.

Although FIG. 2 and FIGS. 3A-3C depict a charge handle having two alignment fins on opposing sides of an exemplary charge handle housing 100, any number of alignment fins may be employed in any one or more positions on a charge handle without departing from the spirit and scope of the present disclosure. It should be noted that alignment fins may be made from any material, and in some embodiments may be made from a material having a softer quality than the material(s) used in other portions of the charge handle 1000. For example, in some implementations, the alignment fins are made from a soft rubber material while the neck 101 or core 102 of the housing is made from a harder material (e.g. aluminum, hard plastic, composite, etc.).

Referring back now to FIG. 1, internal to charge handle 1000, housing 100 may be configured to secure or hold any one or more structural, mechanical, electronic, electrical, or other components or elements. For example, housing 100 or any one or more subsections/portions thereof (e.g. neck 101, core 102, and/or tip 103) may be configured to enclose, carry, and/or be coupled with one or more electronic and/or electrical components, including any one or more sensors, conductors, cables/wires, circuits, switches, gates, gauges, transmitters, receivers, transceivers, modems, computer processing components, memory, any or any other electronic or electrical components. Housing 100 may in some embodiments be configured to at least partially enclose a plurality of electrical connectors (e.g. inlet or outlet conductors). As shown, housing 100 may include conductors 110, 113, 114, 202, 204, 206 (also referred to herein as “inlet conductors”). Although only inlet connectors are depicted in FIG. 1, one of ordinary skill in the art will readily appreciate that the housing 100 may in some embodiments be configured to enclose a plurality of outlet connectors instead of inlet connectors, or, in some embodiments include a combination of both inlet and outlet connectors. As shown, one or more of the inlet conductors 110, 113, 114, 202, 204, 206 may be coupled to an energy source (e.g. an AC source, a DC source, etc.) through cable 190. Any one or more of the conductors 110, 113, 114, 202, 204, 206 may be physically accessible through one or more apertures in a faceplate 104 of charge handle 1000 (e.g. accessible to a complementary electrical connector of a charging plug). In some embodiments, charge handle housing 100 may be configured to enclose one or more of: a power supply conductor configured to be coupled with an AC source and/or DC source; a pilot conductor configured to carry a signal that indicates to the vehicle, the vehicle charge port, and/or the charge station that the charge handle is connected to a charge port (e.g. so that charging may commence); a proximity conductor configured to carry a signal that indicates to a vehicle, a vehicle charge port, and/or a charge station that the charge handle 100 is a bout to be disconnected from the charge port; a communication conductor (e.g. a control area network (CAN) conductor) configured to serve as a communication line (e.g. configured to effectuate transmission of information between the charge handle and the vehicle, the vehicle charge port, and/or the charge station) for coordinating information between vehicle systems and the charge handle or charging station; and/or a ground conductor configured to be coupled to a ground.

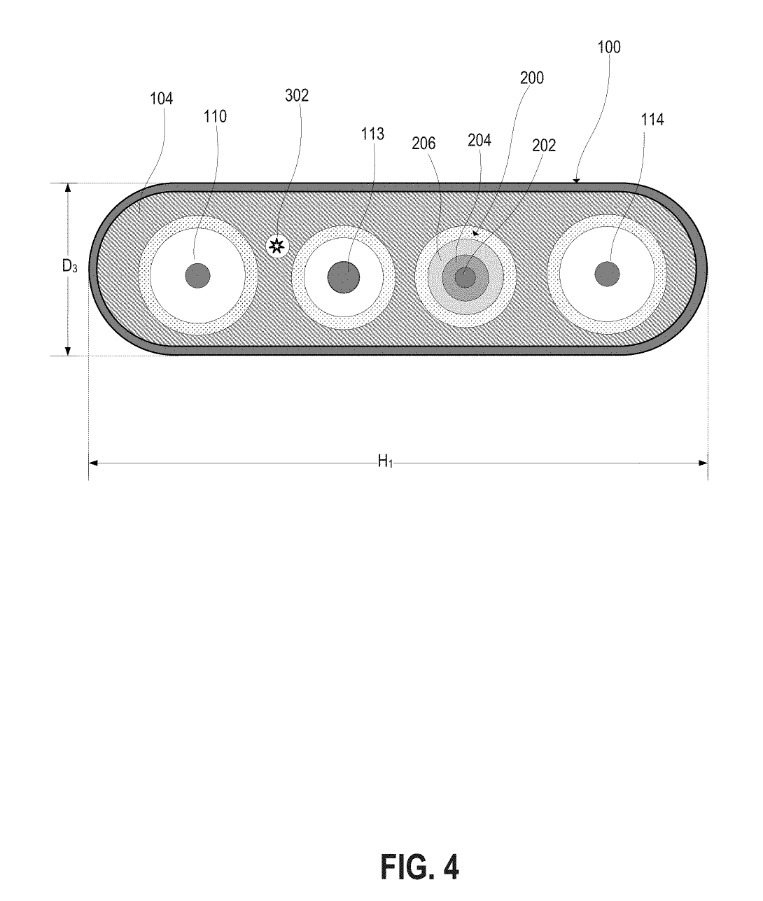

For example, housing 100 may include one or more of an AC level 1 conductor 110, an AC level 2 conductor 114, a ground conductor 113, a proximity conductor 202, a pilot conductor 204, and/or a CAN conductor 206. As depicted, and as discussed in more detail herein with reference to FIG. 4, proximity conductor 202, pilot conductor 204, and/or CAN conductor 206 may be provided in a stacked tip-ring-sleeve configuration. Such a stacked arrangement may minimize the housing dimensions required for a charge handle, thereby lowering the overall profile of the charge handle. For example, an electrical inlet 200 having such a stacked arrangement may serve to reduce or minimize the width dimension, W₁, of charge handle. For example, as depicted in FIG. 1, on account of the tip-ring-sleeve configuration employed with the proximity conductor 202, pilot conductor 204, and CAN conductor 206, the area occupied on the faceplate 104 region of the housing 100 by the access apertures and/or the pin cavities may be reduced and/or minimized.

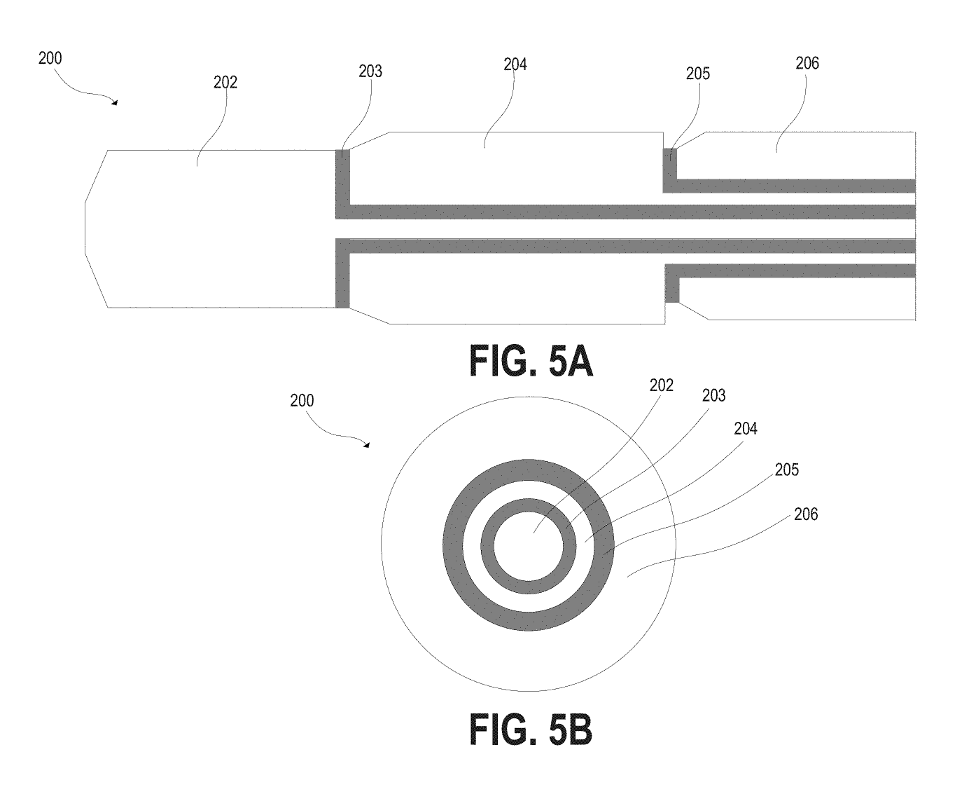

It will be appreciated by one ordinary skill in the art that the tip-ring-sleeve pin configuration disclosed in the present disclosure may be employed with any number or type of conductors desired, and the disclosure is not limited to the arrangement or order of the proximity conductor 202, the pilot conductor 204, and the CAN conductor 206 depicted. For instance, in some implementations, a tip-ring-ring-sleeve conductor arrangement may be utilized to stack four conductors along the same inlet connector column (sometimes referred to herein as a “pin”). In other implementations, a tip-sleeve conductor arrangement may be utilized to stack just two conductors along the same pin/inlet column. In some embodiments, one or more of the conductors in the stacked arrangement may be operatively coupled to a power supply (e.g. an AC power source, a DC power source, etc.), a ground, or any other source or component. Additional details are provided with reference to FIGS. 4 and 5A-5B below.

FIG. 4 illustrates an exemplary arrangement of conductors as carried by an exemplary charge handle housing 100 in accordance with one or more embodiments of the present disclosure. As shown, conductor inlets 110, 113, 200, and 114 are aligned in a substantially linear arrangement (i.e. forming a row) along the width dimension, W₁, of housing 100. In some embodiments, faceplate 104 of housing 100 need only be formed with four or fewer apertures to accommodate (i.e. provide physical access) each of an AC level 1 conductor 110, an AC level 2 conductor 114, a ground conductor 113, a proximity conductor 202, a pilot conductor 204, and/or a CAN conductor 206. As may be observed, the dimensions of housing 100 may be reduced or minimized as such stacked inlet (or outlet) arrangements in accordance with the present disclosure are employed. In particular embodiments, the housing (e.g. at the faceplate 104) includes a first number of apertures providing physical contact access to a second number of charging conductors, wherein the second number of charging conductors is greater than the first number of apertures because two or more charging conductors in a stacked arrangement may be accessed via a single aperture. The stacked configuration of conductor inlet 200 may be provided via a tip-ring-sleeve arrangement of conductor material that together forms a multi-stage inlet connector (e.g. inlet conductor 200) occupying a reduced area within the charge handle, and/or requiring a relatively small space of faceplate 104 for access to each included conductor. Other embodiments of the present technology may use a tip-sleeve conductor arrangement, a tip-ring-ring-sleeve conductor arrangement, or any other stacked arrangement of a number of conductors deployed in connection with an electrical vehicle charge handle (generally with insulation material disposed or situated therebetween to isolate signals).

FIG. 5A illustrates a cross-sectional side view of an exemplary tip-ring-sleeve stacked conductor arrangement (i.e. a multi-stage inlet connector) in accordance with one or more embodiments of the present technology. As shown, a first conductor (e.g. proximity conductor 202) may serve as the tip, a second conductor (e.g. pilot conductor 204) may serve as the ring, and a third conductor (e.g. CAN conductor 206) may serve as the sleeve in the tip-ring-sleeve configuration. In some embodiments, insulating material may be disposed between conductors to ensure that signals do not cross between conductors (i.e. currents passed through said conductors are sufficiently isolated). As shown, a first insulator 203 may be disposed between the first conductor 202 and the second conductor 204, and a second insulator 205 may be disposed between the second conductor 204 and the third conductor 206.

FIG. 5B illustrates a cross-sectional in-plane view of the exemplary tip-ring-sleeve stacked conductor arrangement depicted in FIG. 5A in accordance with one or more embodiments of the present disclosure. As shown, the first conductor (e.g. proximity conductor 202) may serve as the tip, the second conductor (e.g. pilot conductor 204) may serve as the ring (e.g. surrounding a portion of the core conductor material), and the third conductor (e.g. CAN conductor 206) may serve as the sleeve (e.g. surrounding a portion of the ring and/or tip conductor material) in the tip-ring-sleeve configuration. As shown, the first insulator 203 may be disposed between the first conductor 202 and the second conductor 204, and the second insulator 205 may be disposed between the second conductor 204 and the third conductor 206. Although a three-stage multi-stage inlet connector is depicted in FIGS. 5A-5B, one of ordinary skill in the art will appreciate that the disclosed technology may be deployed with any stage stacked arrangement of charge handle conductors without departing from the spirit and scope of the present disclosure.

It should be noted that the discussion of multi-stage inlet connectors of the present disclosure is equally applicable to multi-stage outlet connectors. In particular, any one or more of the embodiments of the present disclosure may include either multi-stage inlet connectors (a stacked inlet pin), or multistage outlet connectors (a stacked outlet receptacle), or any combination of both. Although not specifically depicted in the figures provided with the instant disclosure, one of ordinary skill in the art will readily appreciate that the housing 100 may in some embodiments be configured to enclose a plurality of outlet connectors (one or more of which may be a multi-stage outlet connector) instead of inlet connectors, or, in some embodiments include a combination of both inlet and outlet connectors.

Referring back now to FIG. 1, housing 100 may carry or be coupled with one or more touch sensor(s) 300 configured to receive input from a user (e.g. via a touch of the finger, etc.) and, alone or in combination with one or more actuation components, engage or disengage various functions of charge handle 1000. In some implementations, touch sensor 300 may be operatively coupled with a light source 302 (e.g., a flashlight, an incandescent filament, a light-emitting-diode, etc.). In some embodiments, such light source 302 may be configured to illuminate an area exterior to the housing in front of the charging conductors. Touch sensor(s) 300 may include one or more of a capacitive sensor, a resistive sensor, and/or a piezoelectric sensor.

Touch sensor 300 may include any type of capacitive sensor configured to detect and/or measure one or more of an applied force, a contact, and/or a presence of an object (e.g. a finger). In some instances the capacitive sensor is configured to detect whether the object touching it. In some implementations, such a capacitive sensor may include an electrode positioned behind a non-conductive panel (e.g. glass, plastic, etc.) held by housing 100. It will be appreciated that touch sensor 300 such as a capacitive sensor may be operatively coupled with any one or more components/elements of charge handle 1000 (e.g. to turn them on/off). For example, in some embodiments, capacitance may increase when a user touches the panel with their finger (or other conducting material), consequently triggering a switch (e.g. a capacitance switch). In some implementations, a capacitive touch sensor is operatively coupled with a light source 302 exposed at the faceplate 104 of the housing 100.

In some embodiments, touch sensor 300 may include any type of resistive sensor configured to detect one or more of an applied force, a contact, and/or a presence of an object (e.g. a finger). In some embodiments the resistive sensor may be configured to detect the presence of an electrically conductive object that lowers a resistance between two electrodes. For instance, in some implementations, the resistive sensor may include two electrodes spaced apart from one another. In some exemplary embodiments, upon a user's contact with the sensor, the force applied by the user may push an electrical connector to connect the two electrodes. In some exemplary embodiments, upon a user's contact with the sensor, the electrical properties of the user's finger may lower the resistance between the two electrodes (thereby achieving a closed state, i.e., a turned on state, in connected circuitry). Any such resistive touch sensor 300 may be operatively coupled with any one or more components/elements of charge handle 1000 (e.g. to turn them on/off). In particular, a resistive touch sensor 300 may be configured to engage or disengage one or more functions of charge handle 1000 based on signals transduced by the resistive sensor. In some implementations, a resistive touch sensor is operatively coupled with a light source 302 exposed at the faceplate 104 of the housing 100.

In some other embodiments, touch sensor 300 may include any type of piezoelectric sensor configured to detect forces (e.g. transverse, shear, longitudinal) incident on a piezo ceramic material coupled within a charger handle 1000 circuit such that the piezo sensor may operate or actuate a switch. In some implementations, a piezoelectric touch sensor 300 may include one or more piezoelectric materials cut in a manner that effectuates one or more of a transverse operational mode, a longitudinal operational mode, and/or a shear operational mode—each operable depending on the force applied thereto. In some instances, the output signal of a piezoelectric sensor may be directly related to the amount of mechanical force applied to the material, such that a proportional amount of source voltage may pass through a circuit coupled thereto. The force applied to the piezoelectric sensor may be provided by a user's hand, finger, or other object. A piezoelectric touch sensor 300 may be operatively coupled with any one or more components/elements of charge handle 100 (e.g. to turn them on/off). In particular, a piezoelectric touch sensor 300 may be configured to engage or disengage one or more functions of charge handle 1000 based on signals transduced by the piezoelectric sensor. For example, piezoelectric touch sensor may be operatively coupled with a light source 302 exposed at the faceplate 104 of the housing 100.

Touch sensor(s) 300 may be configured to be sensitive to human touch in any manner, including any presently known in the art, e.g., force/pressure applied by human touch, temperature difference apparent upon human touch, or any other change or difference detectable by a resistive, capacitive, and/or piezoelectric sensor. In some embodiments, touch sensors include capacitive sensors configured to detect and/or recognize biometrics of a user (e.g. fingerprint, live tissue proximity, heartbeat, heat etc.). In some implementations, touch sensor(s) 300 may be operatively coupled with a switch that is normally open, but closes upon actuation via the touch sensor 300 when the touch sensor 300 is engaged (e.g. when the touch sensor 300 is being touched by a human). In some implementations, touch sensor 300 may be configured with basic control logic wherein a switch may be toggled between closed and open configurations (e.g. effectuating an on mode/off mode for particular functionality of charge handle 1000) with each touch sensed by the touch sensor 300.

As depicted in FIG. 1, touch sensor 300 may be carried by housing 100 such that a user may engage the touch sensor 300 by touching a portion of the sensor assembly accessible to a user's finger or other body part (or other object). As shown, touch sensor 300 may be operatively coupled to light source 302. Upon being touched by a user's finger, touch sensor 300 may cause the light source 302 to switch on or off. For instance, touching the touch sensor 300 once may switch the light source 302 on, and touching it again may turn the light source 302 off. Each time the touch sensor 300 is touched, it may switch the light source 302 (e.g. an incandescent filament, a light-emitting-diode) between an on mode and an off mode—in some instances by actuating one or more switches (not shown) controlling current flow to the light source 302. In some embodiments, the light source may be configured to illuminate an area exterior to the housing in front of the charging conductors.

Although the touch sensor 300 of FIG. 1 has been described as being operatively coupled with the light source 302, touch sensor 300 may be operatively coupled with any one or more electrical or electronic components of charge handle 1000, or be configured to actuate any one or more switches or cause control logic to activate, deactivate or otherwise control one or more features of charger handle 1000. In particular, touch sensor 300 may be configured to control (e.g. activate or deactivate) the supply of current to conductor 110 and/or conductor 114, to control the current flow to or signal transmission over any one or more of the proximity conductor 202, pilot conductor 204, and/or CAN conductor 206 of multistage inlet connector 200. Each time the touch sensor 300 is touched or otherwise triggered, it may switch any one or more of the foregoing between an on mode and an off mode—in some instances by actuating one or more switches, e.g., switch 112, switch 115, switch 124, switch 139, or any other switch, gate or other control mechanism operatively coupled therewith.

In some implementations, touch sensor 300 may be operatively coupled with one or more processors configured to execute machine-readable instructions in response to a signal from the touch sensor 300. The machine-readable instructions may be stored in a memory coupled with the one or more processors (e.g. in a microcontroller having RAM, ROM and a CPU) to cause the activation or deactivation of any one or more features or functions of charge handle 1000. When executed by the one or more processors, such machine-readable instructions may effectuate the activation of one or more features or functions of charge handle 1000 in accordance with a predefined relationship between an input as transduced by the touch sensor 300, and an output associated therewith.

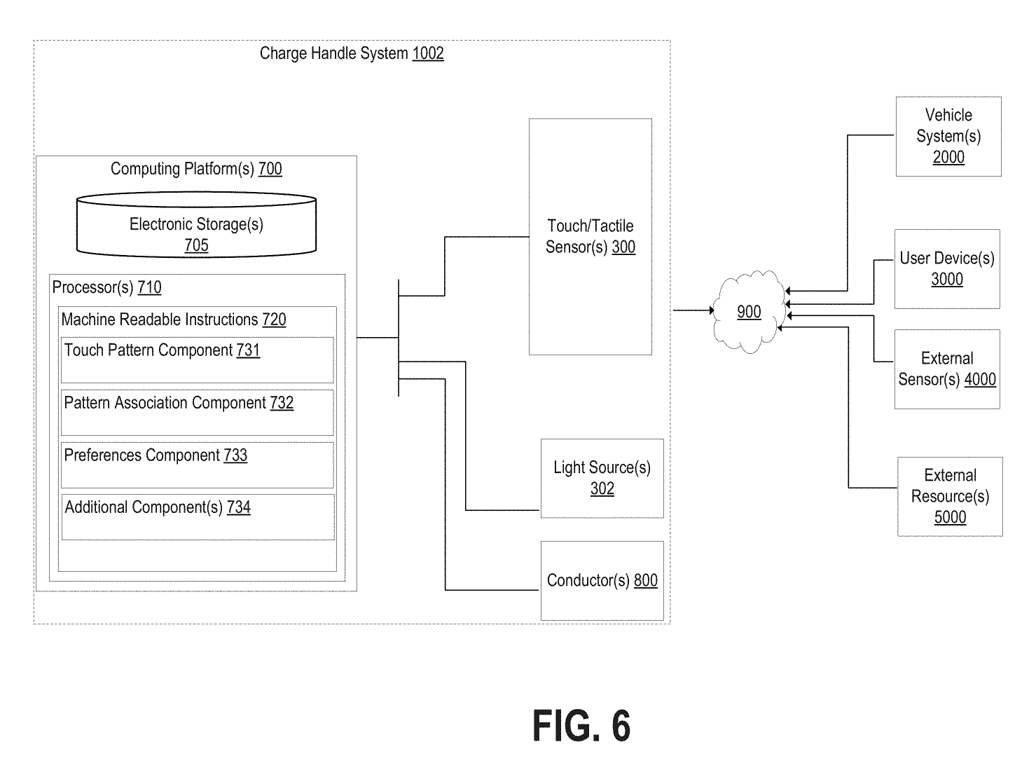

FIG. 6 illustrates a component diagram of an exemplary charge handle system including touch sensor(s) 300 that may be implemented in accordance with one or more embodiments of the present technology. As shown, charge handle system 1002 may include one or more touch sensor(s) 300 operatively coupled with one or more computing platform(s) 700. Computing platform 700, or any one or more of electronic storage 705, processors 710, or other components of computing platform 700 may be onboard the charge handle (i.e. carried by the housing 100 of charge handle 1000), offboard the charge handle (e.g. incorporated into the charging station, the charging port, an user device 3000, a vehicle system 2000, an external resource 5000, or otherwise). Although FIG. 6 depicts computing platform 700 as a separate unit from the touch sensor(s) 300 itself, it should be appreciated that any distinct or combined configuration may be employed within the scope of the present disclosure. For example, in some embodiments, computing platform may be embodied in a microcontroller (including a CPU, ROM, RAM, etc.) that is combined on the same PCB as the touch sensor(s) 300. Any and all such configurations where touch sensor(s) 300 are operatively coupled to a computing platform 700 capable of executing instructions in control logic are intended to fall within the scope of the present disclosure. As depicted, a computing platform 700 in accordance with the present disclosure may include or be operatively coupled with electronic storage 705, one or more processors 710 configured to execute machine-readable instructions 720. Machine-readable instructions 720 may include one or more computer program components including instructions that, when executed, effectuate various operations and feature functionality of a charge handle 1000 in accordance with charge handle system 1002. Such computer program components may include one or more of a Touch Pattern Component 731, a Pattern Association Component 732, a Preferences Component 733, and/or additional components 734.

Touch Pattern Component 731 may be configured to obtain touch event information from touch sensor 300 and identify a touch pattern associated with the touch event information. The touch event information received may provide indicia of (i) the timing of one or more touch event(s)—i.e., the amount of time the touch sensor 300 was in contact with the signal triggering object (e.g. how long the user's finger was in contact with the sensor), (ii) the number of distinct/separate touch events within a given timeframe—i.e., the number of triggering contacts that were made with a signal triggering object within a given timeframe (e.g. how many times the user's finger touched down and lifted off in a given timeframe), (iii) the amount of time that lapsed between each distinct/separate touch event that was made with a signal triggering object, (iv) the force/pressure/heat/etc. detected in connection with the signal triggering object (e.g. the force with which a user's finger contacted/pressed the touch sensor), (v) a biometric pattern detected by the touch sensor (e.g. a fingerprint profile), (vi) any other qualities and/or attributes about a touch event, i.e. any other details of or about a contacting object that triggered the touch sensor to generate the information, and/or (vii) any other differences in one or more qualities or differences between a first distinct touch event and a second distinct touch event. Touch Pattern Component 731 may obtain and/or utilize this information to identify a touch pattern associated with the information. Touch patterns may be predetermined and/or predefined (as discussed herein in connection with Preferences Component 733) by a user, or predetermined and/or predefined by an OEM, a supplier, a distributor, a retailer, or other entity in the form of a default preference. Such predefined touch patterns may also be referred to as templates, or touch pattern templates.

For example, one such exemplary touch pattern template may be defined as two consecutive touches, a first touch followed by a second touch within a certain period of time, e.g., within one second of the first touch. Any touching events or series of touching events that satisfy the template criteria may be categorized or otherwise associated with the activation or deactivation of certain functionality of handle 100. In some embodiments, multiple touch-pattern templates may be predefined using multiple rules and/or criteria. In some implementations, a memory associated with computing platform 700 may store a database or lookup table providing definitions of and associations made with respect to different touch pattern template. An exemplary lookup table that may be utilized in accordance with one or more embodiments of the present technology is shown below in Table 1.0.

TABLE 1.0

| | Pattern/Template Name | Pattern Criteria |
|---|---|---|
| 1 | Pattern A: Single Tap | a first touch not followed by a second |
| | | touch within the following 1 second |
| | | from end-of-touch time of the first touch |
| 2 | Pattern B: Double Tap | a first touch followed by a second touch |
| | | within 1 second from end-of touch time |
| | | of the first touch, but not followed by a |
| | | third touch within the following 1.0 from |
| | | end-of touch time of the second touch |
| 3 | Pattern C: Triple Tap | a first touch followed by a second touch |
| | | within 1 second from end-of-touch time |
| | | of the first touch, further followed by a |
| | | third touch within 1 second from end-of- |
| | | touch time of the second touch. |
| 4 | Pattern D: Tap&Hold | a first touch having a duration longer |
| | | than 1 second, the first touch not |
| | | followed by a second touch within the |
| | | following 1 second from end-of-touch |
| | | time of the first touch |
| 5 | Pattern E: Tap + | a first touch having a duration less than |
| | Tap&Hold | 1 second followed by a second touch |
| | | within 1 second from end-of touch time |
| | | of the first touch, the second touch |
| | | having a duration longer than 1 second, |
| | | the second touch not followed by a third |
| | | touch within the following 1 second |
| | | from end-of-touch time of the second |
| | | touch |
| 6 | [any name] | [any desired criteria or combination of |
| | | criteria] |

As may be seen in Table 1.0, any criteria may be used to establish or define the parameters, preference, templates or other basis for Touch Pattern Component 731 to rely upon in identifying a pattern associated with particular touch events. Table 1.0 includes five pattern templates that may generally be described as: (1) a single tap pattern, (2) a double tap pattern, (3) a triple tap pattern, (4) a tap and hold pattern, and (5) a tap followed by a tap and hold pattern. Touch Pattern Component 731 may be configured to identify any number of patterns that have occurred based on touch pattern templates as provided by any number of criteria. One of ordinary skill in the art will appreciate that, without departing from the scope and spirit of the present disclosure, in some instances Touch Pattern Component 731 may only be configured to identify or detect a single touch pattern based on a single touch pattern template (e.g. based on a single criteria/rule); and in other instances Touch Pattern Component 731 may be configured to identify or detect any number of touch patterns based on any number of touch pattern criteria. In some implementations, one or more of the touch patterns detectable by Touch Pattern Component 731 may be associated with a command that effectuates one or more features of charge handle 100. In some embodiments, this association is made via Pattern Association Component 732.

Pattern Association Component 732 may be configured to obtain touch pattern or template information identified, obtained, and/or generated by Touch Pattern Component 731 and identify an operation associated with or otherwise related to the touch pattern information. For example, Pattern Association Component 732 may obtain information (e.g. via Touch Pattern Component 731 and/or touch sensor 300) indicating that a single tap touch event (e.g. Pattern A in Table 1.0) has just occurred, and identify that such pattern is associated with changing the on/off status of light source 302, for instance. Upon identifying the operation associated with the touch pattern that has just occurred, Pattern Association Component 732 may effectuate the operation via one or more processors 710 operatively coupled with the feature (e.g. the light source 302). For example, the operation may include turning the light source 302 on or off, adjusting the intensity of the light coming from the light source 302, changing the wavelength of the light, activating a blinking mode of the light source 302, etc. In another example, upon identifying the operation associated with a touch pattern that has just occurred, Pattern Association Component 732 may effectuate an operation via one or more processors 710 operatively coupled one or more of the conductors (e.g. activating or connecting an AC power supply to conductor 110 from the AC power line fed in through cable 190. One of ordinary skill in the art will appreciate that Pattern Association Component 732 may effectuate (e.g. activate, deactivate, enhance, or otherwise control) any one or more features of charge handle 1000 in any manner, including by causing a switch to open or close, providing a power supply to a feature that is otherwise in an off state, providing current through a feedback loop, or any other mechanism.

Preferences Component 733 may be configured to obtain input from a user or other source (e.g. an OEM, a supplier, a computer program, etc.) to define or select the criteria that define touch patterns or templates of significance. Preferences Component 733 may facilitate storage of such criteria and/or definitions in electronic storage 705 or elsewhere. Preferences Component 733 may receive input from a user in any manner, including any manner known or recognized in the art. For example, charge handle 1000 may be operatively coupled with a user device 3000 (e.g. a user's smartphone) via communications link 900 (e.g. via Internet protocol, Bluetooth protocol) whereby a user may input, select, and/or define pattern criteria and operation associations (e.g. via a graphical user interface provided on a smartphone in communication—directly or indirectly—with Preferences Component 733).

Although the foregoing examples have been directed to operations of the charge handle 100 that may be activated or otherwise controlled by various touch patterns incident upon touch sensor(s) 300, it should also be noted that the touch sensor(s) 300 and associated components (touch pattern component 731, pattern association component 732, etc.) may be configured, alone or together, to activate, deactivated, enhance or otherwise control any one or more operation(s) of (i) vehicle systems 2000 for a vehicle with which the charge handle may be connected, (ii) the charging station to which the handle is coupled (e.g. via cables), and/or (iii) any other user device 3000, or external resource 5000.

For example, one touch pattern and touch pattern template may be associated with the operation of opening and/or closing a charging port door concealing the charge port of the vehicle. In another example, one touch pattern may be associated with the operation of activating and/or deactivating a vehicle's HVAC systems. In another example, one touch pattern may be associated with the operation of turning on the vehicle's headlights, tail lights, interior lights and/or stereo. In another example, one touch pattern may be associated with the operation of providing a user with an audible or visual status report concerning the charge status of the battery (e.g. an audible or visual indication of the present charge in the battery as a percentage of the full capacity, an estimate of a distance that may be traveled on the current charge, an estimated time to reach 100% charge using the current power source), or any other measures or status indications that may be accessible to charge handle system 1002 incorporated in charge handle 1000. Audible indications may be provided by a speaker (not shown) coupled with charge handle 100. Visual indications may be provided via LED indicators embedded in or otherwise carried by housing 100, and/or via graphics displayed on a GUI (via a user device operatively coupled therewith, or a display (not shown) provided on the housing 100 of charge handle 1000, etc.).

It should be noted that touch sensor(s) 300 maybe made of any material, including copper, indium tin oxide (ITO), FR-4 (a composite material made up of woven fiberglass cloth with an epoxy resin flame resistant binder), any semiconductor materials, and/or any piezoelectric materials. In some implementations, one touch pattern or biometric detection may be associated with the operation of adjusting the position of a driver's seat in the vehicle. In some implementations, charge handle 100 may be configured with a capacitive sensor that may detect biometrics associated with the user touching the capacitive sensor.

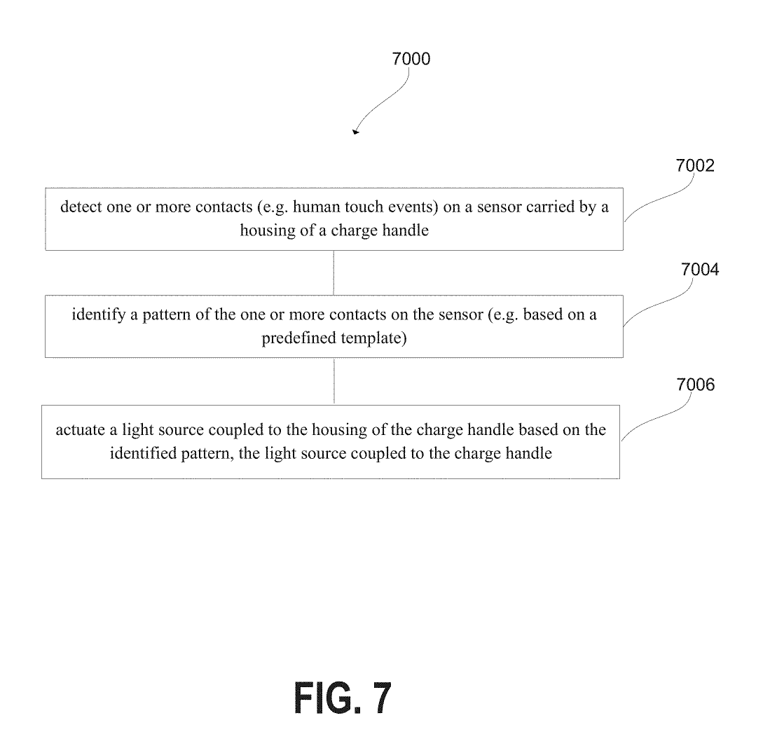

FIG. 7 illustrates a flow chart of a method that may be implemented by charge handle systems in accordance with one or more embodiments of the present disclosure. As shown, at operation 7002, method 7000 may detect a user interaction with the sensor, for example, one or more contact occurrences (e.g., human touch events), via a touch sensor, e.g., capacitive sensor, carried by a housing of a charge handle. At operation 7004, method 7000 may identify a pattern of the one or more contact occurrences incident on the capacitive sensor based on a predefined template. At operation 7006, method 7000 may actuate a light source coupled to the housing of the charge handle based on the identified pattern of the one or more contact occurrences, the light source coupled to the faceplate of the charge handle. In some other embodiments, method 7000 may actuate any charge handle feature or vehicle feature with which it is operatively coupled, based on the identified pattern of the one or more contact occurrences.

Referring back now to FIG. 1, charge handle 1000 may include one or more movement sensor(s) 400 configured to detect when charge handle 1000 has been picked up or set down by a user. Upon detecting one or more such movements, movement sensor(s) 400 may—alone or in combination with one or more elements/components of charge handle 1000—activate, deactivate, or otherwise control one or more power supply conductors (e.g. AC Line 1 conductor 110, AC Line 2 conductor 114, DC conductor, etc.) and/or any other conductors (e.g. proximity conductor 202, pilot conductor 204, and/or CAN conductor 206). Movement sensor(s) 400 may include any sensor configured to detect motion, proximity, position and/or relative spatial location of the charge handle 1000.

For example, in some embodiments, movement sensor 400 may be a motion sensor such as an accelerometer, which is configured to detect motion associated with charge handle 1000 when housing 100 is moved. In some embodiments, motion sensor 400 may be operatively coupled with one or more computer program components configured to determine whether or not the detected motion and/or path of motion corresponds to a movement pattern (e.g. a predefined pattern template) or otherwise indicates that the handle has been picked up or set down by a user. In some embodiments, movement sensor 400 may be a proximity sensor such as an RF tag configured to detect and/or be used to detect when the charge handle 100 has entered into or been removed from a particular zone (e.g. within a defined range of an RF sensor associated therewith). Although such an RF tag cannot alone detect or provide as much information as an accelerometer type movement sensor, it may nevertheless detect movement into and out of a predefined zone (e.g. the zone of the RF receiver). In some embodiments, proximity sensor 100 may be operatively coupled with one or more computer program components configured to determine whether or not the proximity or location of the charge handle as indicated by the proximity sensor corresponds to or otherwise indicates that the handle has been picked up or set down by a user (e.g. determining whether the charge handle has been moved into or out of the zone, e.g., near the charge station). In some embodiments, movement sensor 400 may be a proximity sensor such as a magnetic proximity sensor configured to detect when the charge handle is in close enough proximity to a complementary magnetic sensor receiver that it may magnetically interact therewith. For example, when the charge handle 1000 is hung up in the charge station such that the magnetic sensor carried by the housing 100 is in close proximity to the complementary magnetic sensor receiver in the charge station, it may be detected or otherwise determined that the charge handle 1000 is not in use (or has been set down by a user). When the proximity of the magnetic sensor carried by housing 100 to the complementary magnetic sensor receiver in the charge station is detected to change such that the magnetic interaction is weakened, it may be determined that the charge handle 1000 has been picked up by a user (or otherwise removed from the charge station). One of ordinary skill in the art will appreciate that any type of sensor or set of sensors configured to detect movement, proximity, or spatial positioning may be employed without departing from the scope of the present disclosure. In some embodiments, once it has been detected/determined that the handle has been picked up, various other functionality of the charge handle 1000 and/or a vehicle may be actuated based on that determination.

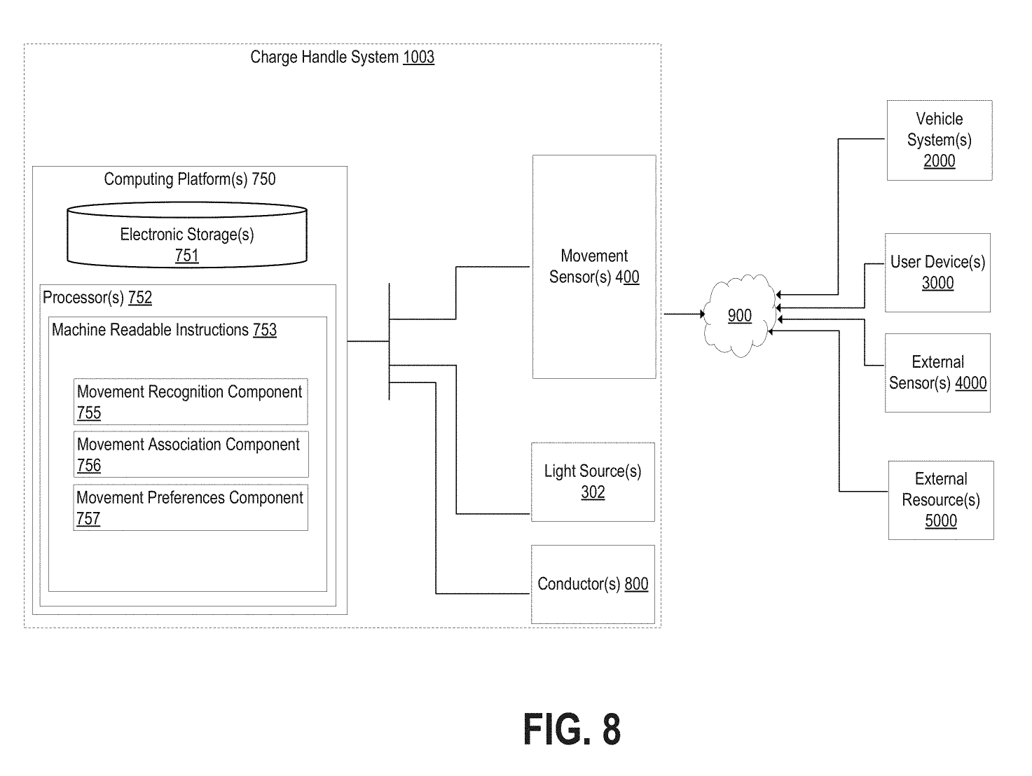

FIG. 8 illustrates a component diagram of an exemplary charge handle system 1003 including movement sensor(s) 400 that may be implemented in accordance with one or more embodiments of the present technology. As shown, charge handle system may include one or more movement sensor(s) 400 operatively coupled with one or more computing platform(s) 750 onboard the charge handle (e.g., carried by the housing 100 of charge handle 1000). Computing platform 750 may or may be the same or different from the computing platform 700 described hereinabove with reference to FIG. 6. One of ordinary skill in the art will appreciate that any one or more onboard computing platforms may be utilized alone or together to effectuate the various features of the charge handle technology disclosed herein. Although FIG. 8 depicts computing platform 750 as a separate unit from the movement sensor 400 itself, it should be appreciated that any separate or combined configuration may be employed within the scope of the present disclosure. For example, in some embodiments, computing platform 750 may be embodied in a microcontroller (including a CPU, ROM, RAM, etc.) that is combined on the same PCB as the movement sensor 400. Computing platform 750, or any one or more of electronic storage 751, processors 752, or other components of computing platform 750 may be onboard the charge handle (i.e. carried by the housing 100 of charge handle 1000), offboard the charge handle (e.g. incorporated into the charging station, the charging port, an user device 3000, a vehicle system 2000, an external resource 5000, or otherwise). Any and all such configurations where movement sensor 400 are operatively coupled to a computing platform 750 capable of executing instructions in control logic are intended to fall within the scope of the present disclosure. As depicted, computing platform 750 in accordance with the present disclosure may include or be operatively coupled with electronic storage 751, one or more processors 752 configured to execute machine-readable instructions 753. Machine-readable instructions 753 may include one or more computer program components including instructions that, when executed, effectuate various operations and feature functionality of charge handles 1000 incorporating charge handle system 1003 (which may be the same or similar to charge handle system 1002). Such computer program components may include one or more of a Movement Recognition Component 755, Movement Association Component 756, and/or a Movement Preferences Component 757.

Movement Recognition Component 755 may be configured to obtain movement information from movement sensor(s) 400, and identify a movement pattern (e.g. in the case of a motion sensor) or a location/presence/proximity within a particular zone or position (e.g. in the case of proximity sensor) based on that movement information. The movement information received may provide indicia of (i) a path of motion of charge handle 1000, (ii) a speed or acceleration measure of movement of the charge handle 1000, (iii) spatial location of charge handle 1000, (iv) a presence of charge handle 1000 within a spatial zone or region, (v) the proximity of charge handle 1000 to a particular location or object (e.g. the charge station), (vi) a direction of movement of charge handle 1000, (vii) a height above ground level of charge handle 1000, (viii) a distance (e.g. horizontal, vertical, etc.) of charge handle 1000 from a predefined point in space or from a predefined object (e.g. distance from an auxiliary sensor in communication with the movement sensor of the charge handle), (ix) a rotation of charge handle 1000, (x) an orientation or pose of charge handle 1000, and/or (xii) any other qualities and/or attributes about movement of charge handle 1000. Movement Recognition Component 755 may obtain and/or utilize this movement information to identify a movement pattern or location/proximity/position associated with the information. Movement Recognition Component 755 may obtain and/or utilize this information to identify a movement pattern associated with the information. Movement patterns may be predetermined and/or predefined (as discussed herein in connection with Preferences Component 733) by a user, or predetermined and/or predefined by an OEM, a supplier, a distributor, a retailer, or other entity in the form of a default preference. Such predefined movement patterns may also be referred to as movement pattern templates.

Movement Association Component 756 may be configured to associate the movement pattern identified by Movement Recognition Component 755 with an operation to be carried out, based on a match between the movement pattern and a predefined movement pattern template. Movement pattern templates may be predetermined and/or predefined in any manner, including by an end-user, or by an OEM, a supplier, a distributor, a retailer, or other entity in the form of a default preference (as discussed herein in connection with Movement Preferences Component 756).

For example, Movement Association Component 756 may obtain information (e.g. via Movement Recognition Component 755 and/or movement sensor 400) indicating that charge handle 1000 has been picked up by a user, and identify that such pattern is associated with the operation of actuating a switch allowing current to flow from a power source to one of the conductors (e.g. conductor 110). Upon identifying the operation associated with a movement pattern that has just occurred, Movement Association Component 756 may effectuate an operation via one or more processors 752 operatively coupled to one or more conductors 800 (e.g. activating or connecting an AC power supply to conductor 110 from the AC power line fed in through cable 190). In another example, upon identifying the operation associated with the movement pattern that has just occurred, Movement Association Component 756 may effectuate an operation via one or more processors 752 operatively coupled with light source 302 (e.g. switching light source 302 on or off). One of ordinary skill in the art will appreciate that Movement Association Component 756 may effectuate (e.g. activate, deactivate, enhance, or otherwise control) any one or more features of charge handle 1000 in any manner, including by causing a switch to open or close (e.g. switch 112, 115, 124, 139, etc. of FIG. 1), providing a power supply to a feature that is otherwise in an off state, providing current through a feedback loop, or any other mechanism. One of ordinary skill in the art will appreciate that, without departing from the scope and spirit of the present disclosure, in some instances Movement Association Component 756 may only be configured to identify or detect a single movement pattern based on specific movement pattern criteria (e.g. charge handle pick-up); and in other instances Movement Association Component 756 may be configured to identify or detect any number of movement patterns or locations based on any number of movement pattern criteria. In some implementations, one or more of the patterns detectable by Movement Recognition Component 755 may be associated with a command that effectuates one or more features of charge handle 100. In some embodiments, this association is made via Movement Association Component 756.

Movement Preferences Component 757 may be configured to obtain input from a user or other source (e.g. an OEM, a supplier, a computer program, etc.) to define or select the criteria that define movement patterns or proximity conditions of significance. Movement Preferences Component 757 may facilitate storage of such criteria and/or definitions in electronic storage 751 or elsewhere. Movement Preferences Component 757 may receive input from a user in any manner, including any manner known or recognized in the art. For example, charge handle 1000 may be operatively coupled with a user device 3000 (e.g. a user's smartphone) via communications link 900 (e.g. via Internet protocol, Bluetooth protocol), whereby a user may input, select, and/or define pattern criteria and operation associations (e.g. via a graphical user interface provided on a smartphone in communication—directly or indirectly—with Movement Preferences Component 757).

For example, a user may define a movement template by actually performing the motions of picking the charge handle up off of a charge station and/or setting it back into/onto the charge station while corresponding information from the movement sensor 400 is being recorded. Such template movement information from movement sensor(s) 400 may be obtained and/or stored by Movement Association Component 756 and/or Movement Preferences Component 757 (e.g. in electronic storage 751). Movement Association Component 756 may later utilize such template information or indicia thereof to recognize future movement events that correspond to the same or similar motion. Other entities such as OEM's may preconfigure the Movement Preferences Component 757 with predefined movement information indicating when the charge handle has been picked up or set down. Such information may be provided as a range of indicative movement information, an average of indicative movement information with upper and lower delta limits, etc. One of ordinary skill in the art will appreciate that any movement information may be predefined as a template such that when similar motions occur, an inference may be drawn that a certain event has occurred (e.g. the handle has been picked up).

Although the foregoing examples have been directed to operations of the charge handle 1000 that may be activated or otherwise controlled by various movement patterns sensed by movement sensor(s) 400, it should also be noted that the movement sensor(s) 400 and associated components (movement recognition component 755, movement association component 756, etc.) may be configured, alone or together, to activate, deactivate, enhance or otherwise control any one or more operation(s) of (i) vehicle systems 2000 for a vehicle with which the charge handle may be connected, (ii) the charging station to which the handle is coupled (e.g. via cables), and/or (iii) any other user device 3000, or external resource 5000.

For example, one movement pattern may be associated with the operation of opening and/or closing a charge port door concealing the charge port of the vehicle. In another example, a movement pattern may be associated with the operation of activating and/or deactivating a vehicle's HVAC systems. In another example, a movement pattern may be associated with the operation of turning on the vehicle's headlights, tail lights, interior lights and/or stereo. In another example, a movement pattern may be associated with the operation of providing a user with an audible or visual status report concerning the charge status of the battery (e.g. an audible or visual indication of the present charge in the battery as a percentage of the full capacity, an estimate of a distance that may be traveled on the current charge, an estimated time to reach 100% charge using the current power source, or any other measures or status indications that may be accessible to charge handle system 1003 incorporated in charge handle 1000). Audible indications may be provided by a speaker (not shown) coupled with charge handle 1000. Visual indications may be provided via LED indicators and/or graphics displayed on a GUI (via a user device operatively coupled therewith, or a display (not shown) provided on the housing 100 of charge handle 1000, etc.).

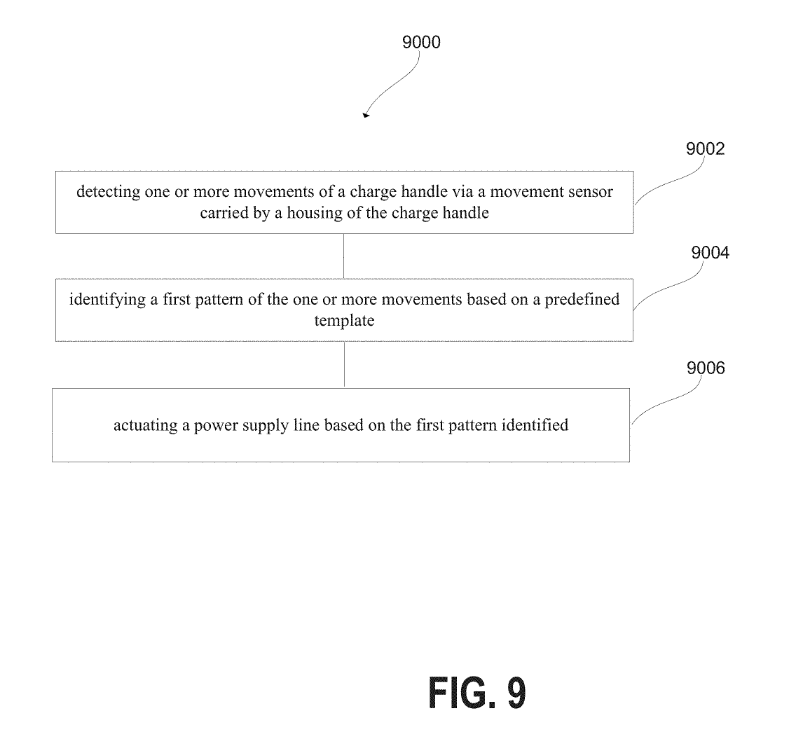

FIG. 9 illustrates a flow chart of a method that may be implemented by charge handle systems in accordance with one or more embodiments of the present disclosure. As shown, at operation 9002, method 9000 may detect one or more movements of a charge handle via a movement sensor carried by a housing of the charge handle. At operation 9004, method 9000 may identify a first pattern of the one or more movements based on a predefined template. At operation 9006, method 9000 may actuate a power supply line based on the first pattern identified.

Referring back now to housing 100 referenced in FIG. 1, such housing may be of any shape or form. For example, the neck 101, core 102, and/or tip 103 portions may take on any shape or form, exemplary forms of which may be deployed as set forth below.

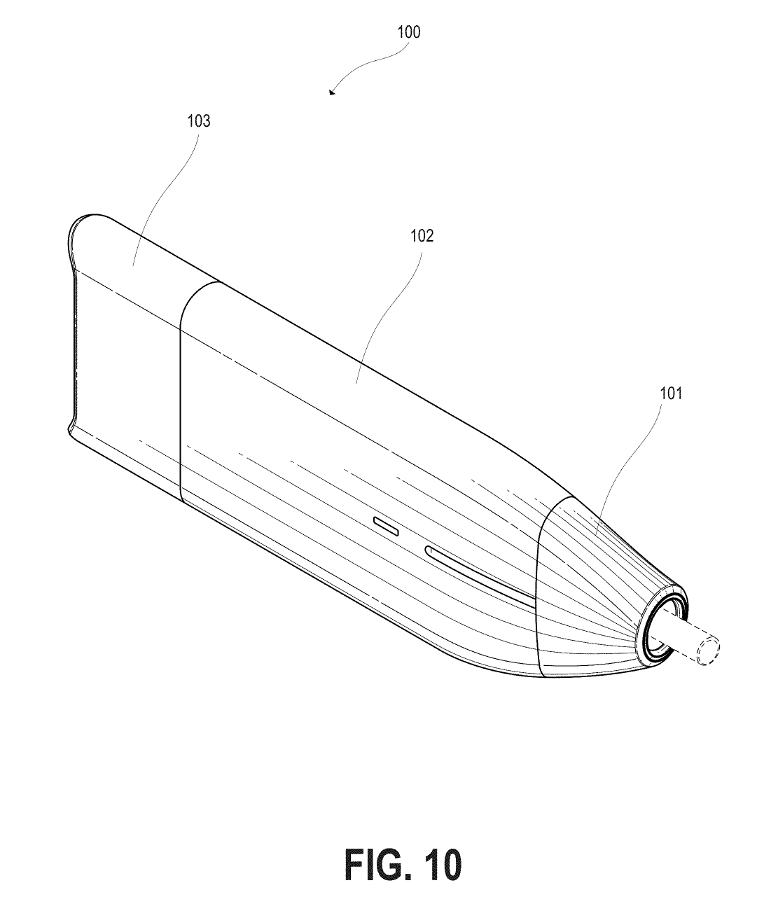

For example, in some embodiments neck 101 may be a substantially hollow sleeve structure defining, in whole or in part, a first opening at one end and a second opening at another end, the first opening being relatively smaller in size (e.g. smaller area) than the second opening. The hollow sleeve structure may be configured with a tapered, flattened, funnel-like configuration spanning from and defining, in whole or in part, a hollow area inside neck 101 between the first opening and the second opening. The profile of the first opening and the profile of the second opening formed by neck 101 may take on any shape or size, and the neck 101 structure that defines the hollow channel between the first opening and the second opening may span the distance between first opening and second opening in any manner, including along any spatial path (e.g. forming a straight taper, a curvilinear taper, a rounded taper, a bent taper, or any combination of the foregoing, etc.). For example, in some implementations the neck 101 structure provides a rigid, rounded surface that tapers along the distance spanning between the second opening and the first opening. In some embodiments, neck 101 resembles circular truncated cone partially flattened in one direction, creating a first and second opening having one or more of the foregoing profiles. In some such embodiments, the circular, truncated, partially flattened cone shape may also have a bent shape (as shown in more detail with reference to FIG. 10). In some implementations, neck 101 is configured such that the profile of the first opening and/or second opening may include one or more of the following shapes: a circle, ellipse, stadium, oval, arch, circular sector, circular segment, lens, crescent, arch, annulus, parallelogram, rounded parallelogram, a polyhedron, a rounded polyhedron, and/or any other shape. For example, the profile of the first opening may be substantially the shape of an ellipse, and the profile of the second opening may be substantially the shape of a rounded rectangle. In some embodiments, the neck 101 structure is configured such that the first opening has a profile that substantially matches an outer profile of a power cord 190 configured to be disposed therein.

In some embodiments, the core 102 may be coupled with, extend from or be an extension of neck 101. Core 102 may be a substantially hollow sleeve structure defining, in whole or in part, a first opening at one end and a second opening at the other end, the first opening being configured to join with (and in some instances substantially match the profile of) the edge of second opening of neck 101. The profile of the core 102 first opening and the profile of the core 102 second opening may be any shape or size. For example, core 102 is configured such that the profile of the first opening and/or second opening of core 102 may take on one or more of the following shapes: a rounded rectangle, a stadium, a circle, ellipse, oval, arch, circular sector, circular segment, lens, crescent, arch, annulus, parallelogram, rounded parallelogram, a polyhedron, a rounded polyhedron, and/or any other shape. In some embodiments, core 102 structure tapers between the first opening and the second opening. The core 102 structure that defines, in whole or in part, the hollow channel between the first opening and the second opening in the core 102 may span the distance between first opening and second opening of the core 102 in any manner, including by following any spatial path or shape (e.g. forming a straight taper, a curvilinear taper, a rounded taper, a bent taper, or any combination of the foregoing, etc.). In some embodiments, the first opening and the second opening defined by the hollow sleeve structure of core 102 may be substantially the same shape, and the hollow sleeve structure may follow a straight path therebetween (i.e. the path not being tapered or curvilinear). For example, in some instances the shape of core 102 resembles an open-ended rectangular cuboid having a length dimension (LC) greater than its height dimension (HC) and a height dimension (HC) greater than its depth dimension (DC), and further having rounded edges. In other embodiments, the first opening and the second opening may have different sizes, and thus the hollow sleeve structure of core 102 may be at least partially tapered. In some embodiments, at least a portion of the core 102 structure may have a bent shape such that the path between the first opening and the second opening of core 102 is at least partially curvilinear. In some embodiments, core 102 structure is configured such that the edge along the first opening has a profile that substantially matches the edge along the second opening of neck 101. Exemplary such embodiments are depicted in FIGS. 10-13B.

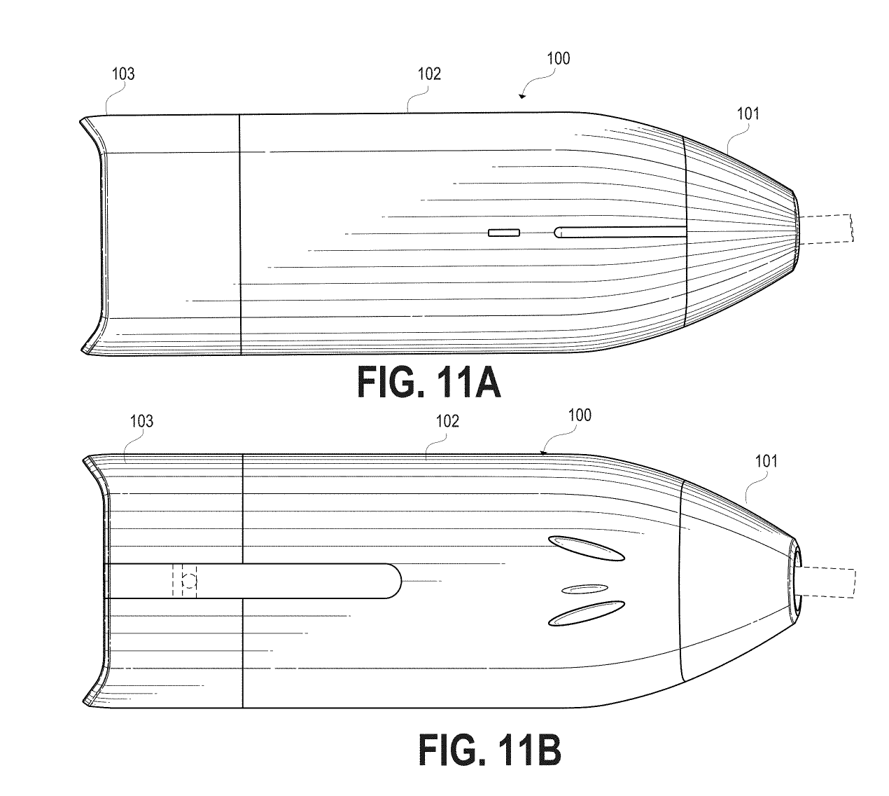

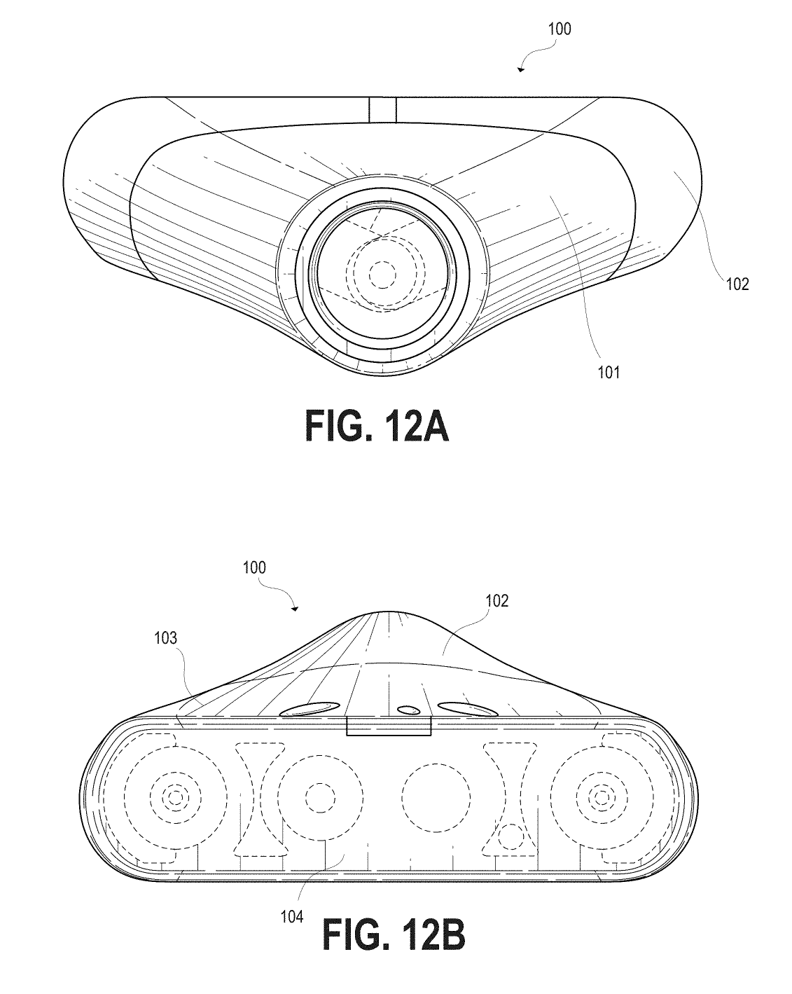

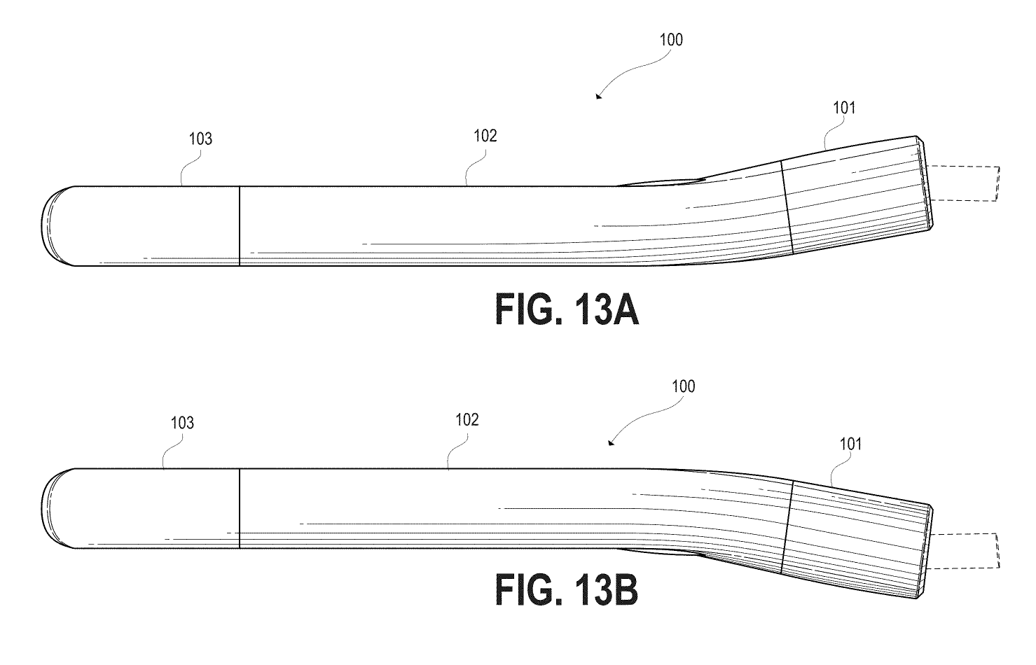

FIG. 10 is a perspective view of an exemplary charge handle housing in accordance with one or more embodiments of the present disclosure. As shown, the neck 101, core 102, and tip 103 portions are configured to couple together to form the housing 100 enclosure. FIG. 11A is a top view of an exemplary charge handle housing in accordance with one or more embodiments of the present disclosure. FIG. 11B is a bottom view of an exemplary charge handle housing in accordance with one or more embodiments of the present disclosure. FIG. 12A is a rear view of an exemplary charge handle housing in accordance with one or more embodiments of the present disclosure. FIG. 12B is a front view of an exemplary charge handle housing in accordance with one or more embodiments of the present disclosure. FIG. 13A is a first side view of an exemplary charge handle housing in accordance with one or more embodiments of the present disclosure. FIG. 13B is a second side view of an exemplary charge handle housing in accordance with one or more embodiments of the present disclosure.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

A person skilled in the art will appreciate that various exemplary logic blocks, modules, circuits, schemes, and algorithm steps described with reference to the disclosure herein may be implemented as specialized electronic hardware, computer software, or a combination of electronic hardware and computer software. For examples, the modules/units may be implemented by one or more processors to cause the one or more processors to become one or more special purpose processors to executing software instructions stored in the computer-readable storage medium to perform the specialized functions of the modules/units.

The flowcharts and block diagrams in the accompanying drawings show system architectures, functions, and operations of possible implementations of the system and method according to multiple embodiments of the present invention. In this regard, each block in the flowchart or block diagram may represent one module, one program segment, or a part of code, where the module, the program segment, or the part of code includes one or more executable instructions used for implementing specified logic functions. It should also be noted that, in some alternative implementations, functions marked in the blocks may also occur in a sequence different from the sequence marked in the drawing. For example, two consecutive blocks actually can be executed in parallel substantially, and sometimes, they can also be executed in reverse order, which depends on the functions involved. Each block in the block diagram and/or flowchart, and a combination of blocks in the block diagram and/or flowchart, may be implemented by a dedicated hardware-based system for executing corresponding functions or operations, or may be implemented by a combination of dedicated hardware and computer instructions.

As will be understood by those skilled in the art, embodiments of the present disclosure may be embodied as a method, a system or a computer program product. Accordingly, embodiments of the present disclosure may take the form of an entirely hardware embodiment, an entirely software embodiment or an embodiment combining software and hardware for allowing specialized components to perform the functions described above. Furthermore, embodiments of the present disclosure may take the form of a computer program product embodied in one or more tangible and/or non-transitory computer-readable storage media containing computer-readable program codes. Common forms of non-transitory computer readable storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same.

Embodiments of the present disclosure are described with reference to flow diagrams and/or block diagrams of methods, devices (systems), and computer program products according to embodiments of the present disclosure. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a computer, an embedded processor, or other programmable data processing devices to produce a special purpose machine, such that the instructions, which are executed via the processor of the computer or other programmable data processing devices, create a means for implementing the functions specified in one or more flows in the flow diagrams and/or one or more blocks in the block diagrams.

These computer program instructions may also be stored in a computer-readable memory that can direct a computer or other programmable data processing devices to function in a particular manner, such that the instructions stored in the computer-readable memory produce a manufactured product including an instruction means that implements the functions specified in one or more flows in the flow diagrams and/or one or more blocks in the block diagrams.

These computer program instructions may also be loaded onto a computer or other programmable data processing devices to cause a series of operational steps to be performed on the computer or other programmable devices to produce processing implemented by the computer, such that the instructions (which are executed on the computer or other programmable devices) provide steps for implementing the functions specified in one or more flows in the flow diagrams and/or one or more blocks in the block diagrams. In a typical configuration, a computer device includes one or more Central Processing Units (CPUs), an input/output interface, a network interface, and a memory. The memory may include forms of a volatile memory, a random access memory (RAM), and/or non-volatile memory and the like, such as a read-only memory (ROM) or a flash RAM in a computer-readable storage medium. The memory is an example of the computer-readable storage medium.

The computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The computer-readable medium includes non-volatile and volatile media, and removable and non-removable media, wherein information storage can be implemented with any method or technology. Information may be modules of computer-readable instructions, data structures and programs, or other data. Examples of a non-transitory computer-readable medium include but are not limited to a phase-change random access memory (PRAM), a static random access memory (SRAM), a dynamic random access memory (DRAM), other types of random access memories (RAMS), a read-only memory (ROM), an electrically erasable programmable read-only memory (EEPROM), a flash memory or other memory technologies, a compact disc read-only memory (CD-ROM), a digital versatile disc (DVD) or other optical storage, a cassette tape, tape or disk storage or other magnetic storage devices, a cache, a register, or any other non-transmission media that may be used to store information capable of being accessed by a computer device. The computer-readable storage medium is non-transitory, and does not include transitory media, such as modulated data signals and carrier waves.

The specification has described methods, apparatus, and systems for an intelligent charge handle for charging in-vehicle batteries. The illustrated steps are set out to explain the exemplary embodiments shown and/or described, and it should be anticipated that ongoing technological development will change the manner in which particular functions are performed. Thus, these examples are presented herein for purposes of illustration, and not limitation. For example, steps or processes disclosed herein are not limited to being performed in the order described, but may be performed in any order, and some steps may be omitted, consistent with the disclosed embodiments. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise.

It will be appreciated that the present invention is not limited to the exact construction that has been described above and illustrated in the accompanying drawings, and that various modifications and changes can be made without departing from the scope thereof. It is intended that the scope of the invention should only be limited by the appended claims.

1. A system for controlling an electric motor, the system comprising:
a position sensor configured to measure a position of a rotor of the electric motor;
an error detector configured to detect an offset between the position measured by the position sensor and an actual position of the rotor, the error detector including:
a signal injector configured to inject a probing signal to a stator of the electric motor, wherein the probing signal includes a high frequency current signal; and
a signal sampler configured to sample a response signal from the stator of the electric motor;
wherein the error detector is configured to derive the offset based on the response signal; and
a current regulator, wherein:
the signal injector is configured to inject the probing signal by inputting a current command in a reference frame to the current regulator during a startup process or within a short period after the rotor starts to rotate; and
the signal sampler is configured to sample the response signal by receiving a voltage command in the reference frame from the current regulator.

2. The system of claim 1, wherein the error detector is configured to:
demodulate the response signal;
filter the demodulated response signal; and
apply a gain factor to the filtered and demodulated response signal to derive the offset.

3. (canceled)

4. The system of claim 1, wherein the high frequency current signal has a frequency in a range between 300 Hz and 800 Hz.

5. (canceled)

6. The system of claim 1, wherein the error detector is configured to detect the offset when the rotor of the electric motor is in a stall position.

7. The system of claim 1, wherein the error detector is configured to detect the offset when a speed of the rotor of the electric motor is below a predetermined threshold.

8. The system of claim 1, wherein the error detector is configured to supply the detected offset to the position sensor to correct the position measured by the position sensor.

9. A method for detecting position measurement errors for an electric motor, the method comprising:
measuring, by a position sensor, a position of a rotor of the electric motor;
injecting a probing signal to a stator of the electric motor by inputting a current command in a reference frame to a current regulator during a startup process or within a short period after the rotor starts to rotate, wherein the probing signal includes a high frequency current signal;
sampling a response signal from the stator of the electric motor by receiving a voltage command in the reference frame from the current regulator; and
deriving, based on the response signal, an offset between the position measured by the position sensor and an actual position of the rotor.

10. The method of claim 9, further comprising:
demodulating the response signal;
filtering the demodulated response signal; and
applying a gain factor to the filtered and demodulated response signal to derive the offset.

11. (canceled)

12. The method of claim 9, wherein the high frequency current signal has a frequency in a range between 300 Hz and 800 Hz.

13. (canceled)

14. The method of claim 9, wherein injecting the probing signal includes:
injecting the probing signal when the rotor of the electric motor is in a stall position.

15. The method of claim 9, wherein injecting the probing signal includes:
injecting the probing signal when a speed of the rotor of the electric motor is below a predetermined threshold.

16. The method of claim 9, further comprising:
supplying the offset to the position sensor to correct the position measured by the position sensor.

17. A motor system, comprising:
an electric motor including a rotor and a stator; and
a motor control system configured to control the electric motor, the motor control system including:
a position sensor configured to measure a position of the rotor;
an error detector configured to detect an offset between the position measured by the position sensor and an actual position of the rotor, the error detector including:
a signal injector configured to inject a probing signal to the stator during a startup process or within a short period after the rotor starts to rotate, wherein the probing signal includes a high frequency current signal; and
a signal sampler configured to sample a response signal from the stator;
wherein the error detector is configured to derive the offset based on the response signal; and
a current regulator, wherein:
the signal injector is configured to inject the probing signal by inputting a current command in a reference frame to the current regulator; and
the signal sampler is configured to sample the response signal by receiving a voltage command in the reference frame from the current regulator.

18. The motor system of claim 17, wherein the electric motor includes a synchronous electric motor.

19. The motor system of claim 18, wherein the electric motor includes an interior permanent magnet (IPM) motor.

20. A chassis for a vehicle, the chassis comprising:
a propulsion system for providing motive torques to at least one wheel of the vehicle, the propulsion system comprising:
an energy storage device configured to store electric energy;
an electric motor including a rotor and a stator; and
a motor control system configured to control energy transfer between the energy storage device and the electric motor, the motor control system including:
a position sensor configured to measure a position of the rotor;
an error detector configured to detect an offset between the position measured by the position sensor and an actual position of the rotor, the error detector including:
a signal injector configured to inject a probing signal to the stator, wherein the probing signal includes a high frequency current signal; and
a signal sampler configured to sample a response signal from the stator;
wherein the error detector is configured to derive the offset based on the response signal; and
a current regulator, wherein:
the signal injector is configured to inject the probing signal by inputting a current command in a reference frame to the current regulator during a startup process or within a short period after the rotor starts to rotate; and
the signal sampler is configured to sample the response signal by receiving a voltage command in the reference frame from the current regulator.
